(19) United States
(12) Patent Application Publication
(10) Pub. No.: US 2007/0267834 A1
(43) Pub. Date: Nov. 22, 2007

(54) Child stroller

(76) Inventors: Keith Amdahl, Chisago City, MN (US); Matthew Burk, Forest Lake, MN (US)

Correspondence Address: MERCHANT & GOULD PC, P.O. BOX 2903, MINNEAPOLIS, MN, 55402-0903, US

(21) Appl. No.: 11/804,056

(22) Filed: May 16, 2007

Related U.S. Application Data
(60) Provisional application No. 60/800,660, filed on May 16, 2006.
(60) Provisional application No. 60/855,852, filed on Oct. 31, 2006.

(51) Int. Cl. B62D 39/00

(52) U.S. Cl. 280/47.38; 280/33.998

(57) ABSTRACT

A child stroller can be arranged into nested, stacked, and/or layered configurations to increase storage density. For example, the nose of a first such stroller can fit within a cavity formed in the rear of a second such stroller. In another embodiment, strollers can include a first interlock arrangement and a second interlock arrangement having complementary geometries, thereby facilitating vertical stacking of the strollers. A bottom surface of the strollers also can include a third interlock arrangement configured to mate with the second interlock arrangement to facilitate layering of the strollers. Embodiments of the stroller also can include an activity bar.

### BACKGROUND

In general, strollers enable adults to efficiently transport children from one place to another. For example, strollers enable adults to transport one or more children around a commercial establishment, such as a mall, a theme park, a shopping center, a museum, a zoo, or any other such location. Strollers can also provide a place for children to rest when not en route to a destination. For example, a child can sit inside of a stroller while waiting in line for an amusement park ride or while a parent converses with another adult.

In some prior systems, strollers can be obtained (e.g., rented by the day) from the commercial establishment. In such systems, the commercial establishment must store the strollers when not in use. In general, the amount of storage space required to store such strollers depends upon the footprint of the strollers (i.e., the amount of ground space occupied by the stroller). In some prior systems, to decrease the amount of necessary storage space, strollers are vertically stacked one-on-top-of-another. Vertical stacking enables multiple strollers to fit within a single footprint. In one example prior system, each vertically stacked pile consists of four strollers.

Lifting each stroller during stacking and unstacking, especially lifting the top stroller onto or from the stack, can cause ergonomic problems, such as stress on the user's back and arms. Stacked strollers can also pose a safety concern. A typical stroller can weigh in the range of about 25-40 pounds. If a stack were ever tipped over, the falling strollers could strike by-standers, thereby causing harm. There is also a risk of damage to the strollers and bystanders as a result of pieces breaking off from the falling strollers upon impact with the ground. Such pieces could ricochet off of the ground to strike by-standers. In some prior systems, however, unstacking a pile of strollers can include purposely pushing over the pile to knock the strollers to the ground, thereby exposing the strollers and bystanders to danger of damage.

There exists a need in the art for an improved child stroller.

### SUMMARY

The invention relates to a child stroller and, more particularly, a child stroller designed to facilitate storage of the stroller.

According to one aspect, the present invention relates to a child stroller configured to nest with other strollers of the same type.

According to another aspect, the present invention relates to a child stroller configured to form a vertical stack with other strollers of the same type.

According to yet another aspect, the present invention relates to a child stroller configured to layer with other strollers of the same type.

According to yet another aspect, the present invention relates to a child stroller including an activity bar.

Certain embodiments of strollers configured according to the principles of the present invention are configured to enable a user to either nest or vertically stack the strollers.

Certain embodiments of strollers configured according to the principles of the present invention include interlock arrangements by which the strollers can securely interface with one another during nesting, stacking, and/or layering.

Certain embodiments of strollers configured according to the principles of the present invention include at least one activity bar configured to pivot between multiple positions.

### BRIEF DESCRIPTION OF THE DRAWINGS

In the drawings in which like elements are identified with the same designation numeral:

FIG. 1 is a front, top perspective view of a stroller according to one embodiment of the invention;

FIG. 2 is a side view of the stroller of FIG. 1;

FIG. 3 is a rear, bottom perspective view of the stroller of FIG. 1;

FIG. 4 is a front, bottom perspective view of the stroller of FIG. 1;

FIG. 5 is a top view of the stroller of FIG. 1;

FIG. 6 is a bottom view of the stroller of FIG. 1;

FIG. 7 is a front view of the stroller of FIG. 1;

FIG. 8 is a rear view of the stroller of FIG. 1;

FIG. 9 is a top, rear view of the stroller of FIG. 1;

FIG. 10 is a rear, bottom perspective view of another embodiment of the stroller of FIG. 1 with one of the back wheels and the handlebar assembly removed;

FIG. 11 is a front view of the brake mechanism portion of the stroller of FIGS. 1-10 shown in a disengaged position, and illustrated with the stroller body portion removed;

FIG. 12 is a top, front perspective view of the brake mechanism of FIG. 11;

FIG. 13 is a cross-sectional view of the stroller of FIG. 1 generally taken along the line 13-13 of FIG. 1 with the handlebar assembly shown in a collapsed position, showing the brake mechanism pivoting from a disengaged position to an engaged position;

FIG. 14 is an exploded view of the brake mechanism of FIG. 13;

FIG. 15 is a top, front view of the brake mechanism of FIG. 11 illustrated in the engaged position;

FIG. 16 is a front view of the brake mechanism of FIG. 15;

FIG. 17 is a perspective view of an embodiment of a stroller with an activity bar in an “in use” position;

FIG. 18 is an exploded view of the activity bar shown in FIG. 17 and the latching system for the activity bar;

FIG. 19 is a partial perspective view of the latching system for the activity bar depicted outside of the activity bar;

FIG. 20 is a perspective view of a portion of the latching system for the activity bar shown in FIG. 19;

FIG. 21 is a perspective view of the stroller of FIG. 17 illustrating the activity bar in a “loading” position;

FIG. 22 is a perspective view of the stroller of FIG. 17 with the activity bar in a “storage” position and the handlebar assembly upright;

FIG. 23 is a perspective view of the stroller of FIG. 17 with the activity bar in a “storage” position and the handlebar assembly collapsed;

FIG. 24 is a bottom, rear perspective view of a stroller of the type of FIG. 10 with a locking arrangement on the bottom surface of the stroller and with a handlebar assembly shown in a collapsed position;

FIG. 25 is a perspective view of a latching system for selectively collapsing and maintaining the handlebar assembly of the stroller of FIG. 24 in an upright position;

FIG. 26 is a side view of the latching system of FIG. 25;

FIG. 27 is an exploded view of the latching system of FIG. 25 and the handlebar assembly of the stroller;

FIG. 28 is a perspective view of the handlebar assembly of the stroller and pins of the latching system;

FIG. 29 is a front view of the stroller of FIG. 23;

FIG. 30 is a perspective view of a group of strollers of the type shown in FIG. 23 illustrated as nested and with the handlebar assemblies collapsed;

FIG. 31 is a side view of the nested group of strollers of FIG. 30;

FIG. 32 is a top view of the nested group of strollers of FIG. 30;

FIG. 33 is a top, front perspective view of the stroller of FIG. 17 having a canopy frame;

FIG. 34 is a rear perspective view of the stroller of FIG. 33;

FIG. 35 is a top, front perspective view of the stroller of FIG. 33 including a canopy with storage pouches;

FIG. 36 is a side view of the stroller of FIG. 35;

FIG. 37 is a top, front perspective view of the stroller of FIG. 35 shown in a “canopy up” configuration with the activity bar in a “storage” position;

FIG. 38 is a side view of a group of strollers of FIG. 37 nested in a “canopy up” configuration;

FIG. 39 is a perspective view of the group of nested strollers of FIG. 38;

FIG. 40 is a perspective view of a stack of four strollers of the type illustrated in FIG. 1;

FIG. 41 is a front view of the stack of strollers of FIG. 40;

FIG. 42 is a side view of the stack of strollers of FIG. 40;

FIG. 43 is a bottom view of the stack of strollers of FIG. 40;

FIG. 44 is a top, rear perspective view of a stroller of FIG. 24, shown in a collapsed configuration;

FIG. 45 is a perspective view of a stack of two strollers of the type shown in FIG. 20, shown as they would appear just prior to being interlocked in a stacked manner with one another;

FIG. 46 is a perspective view of strollers stored in a layered configuration according to the principles of this invention;

FIG. 47 is a cross-sectional view of the layered strollers of FIG. 46;

FIG. 48 is a top view of the layered strollers of FIG. 46;

FIG. 49 is a front view of the layered strollers of FIG. 46;

FIG. 50 is a perspective view of an interlocking system for arranging strollers of the type shown in FIG. 24 in a layered configuration; and

FIG. 51 is a side view of the nested strollers of FIG. 50 in a layered configuration;

FIG. 52 is a front, perspective view of an example stroller from which the activity bar has been removed and on which the handlebar assembly is shown in a collapsed position;

FIG. 53 is a side view of the stroller of FIG. 52;

FIG. 54 is a front view of the stroller of FIG. 52;

FIG. 55 is a top view of the stroller of FIG. 52;

FIG. 56 is a bottom view of the stroller of FIG. 52;

FIG. 57 is a rear, bottom perspective view of a rearward stroller nesting behind a forward stroller;

FIG. 58 is a bottom view of the strollers of FIG. 57 in a fully nested configuration;

FIG. 59 is a rear perspective view of the strollers of FIG. 57 in which one of the rear wheels of each stroller has been removed to reveal lifts extending inwardly from the axle of each stroller;

FIG. 60 is a side view of the strollers of FIG. 58;

FIG. 61 is a rear, perspective view of a stack of strollers having lifts;

FIG. 62 is a rear view of the stack of strollers of FIG. 61;

FIG. 63 is a front view of the stack of strollers of FIG. 61;

FIG. 64 is a rear, bottom perspective view of an example stroller having a nesting shroud extending adjacent the rear wheel of the stroller;

FIG. 65 is a flowchart illustrating an example brake release process;

FIG. 66 is a rear perspective view of a rearward stroller positioned behind a forward stroller, both strollers arranged in a canopy-up configuration;

FIG. 67 is a perspective view of the strollers of FIG. 66 showing the rearward stroller disengaging the brake on the forward stroller;

FIG. 68 is a side view of the strollers of FIG. 67;

FIG. 69 is a flowchart illustrating an example stacking process;

FIG. 70 is a rear, top perspective view of a first stroller positioned behind a second stroller;

FIG. 71 is a side view of the strollers of FIG. 70;

FIG. 72 is a rear, top perspective view of the strollers of FIG. 70 in which the second stroller has been tilted backwards onto the first stroller;

FIG. 73 is a side view of the strollers of FIG. 72;

FIG. 74 is a rear, top perspective view of the strollers of FIG. 70 in which the second stroller has been pivoted backwards about the engagement point between the first and second stroller;

FIG. 75 is a side view of the strollers of FIG. 74;

FIG. 76 is a rear, top perspective view of the strollers of FIG. 70 in which the second stroller has been stacked on top of the first stroller; and

FIG. 77 is a side view of the strollers of FIG. 76.

### DETAILED DESCRIPTION

Embodiments of the invention will be described in detail with reference to the drawings, wherein like reference numerals represent like parts and assemblies throughout the several views. Reference to these embodiments does not limit the scope of the invention, which is limited only by the scope of the claims attached hereto.

The invention relates to a stroller and, more particularly, a child stroller configured to transport one or more passengers around a public area. In some embodiments, the stroller provides one or more activities to entertain the passengers during rest or transport. In other embodiments, the stroller is configured to provide storage for one or more items while transporting the passengers. When not in use, the stroller can be easily and efficiently stored.

In some embodiments, multiple strollers can be horizontally nested so that each stroller touches the ground, but only one stroller occupies a full footprint on the ground. In other embodiments, the strollers can be vertically stacked on top of one another in a pile, thereby enabling multiple strollers to occupy only one footprint. In still other embodiments, however, multiple strollers can be layered so that one nested group of strollers rests upon another nested group of strollers. Nesting, stacking, and layering the strollers each enable high storage density of the strollers.

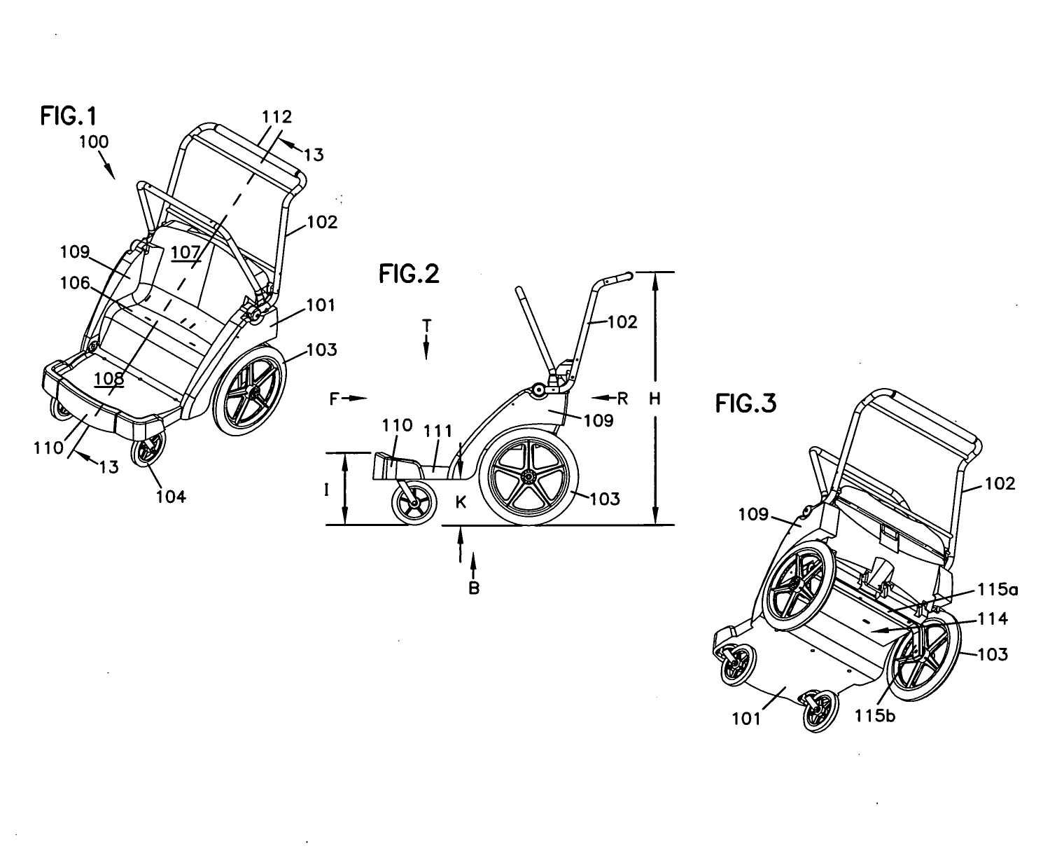

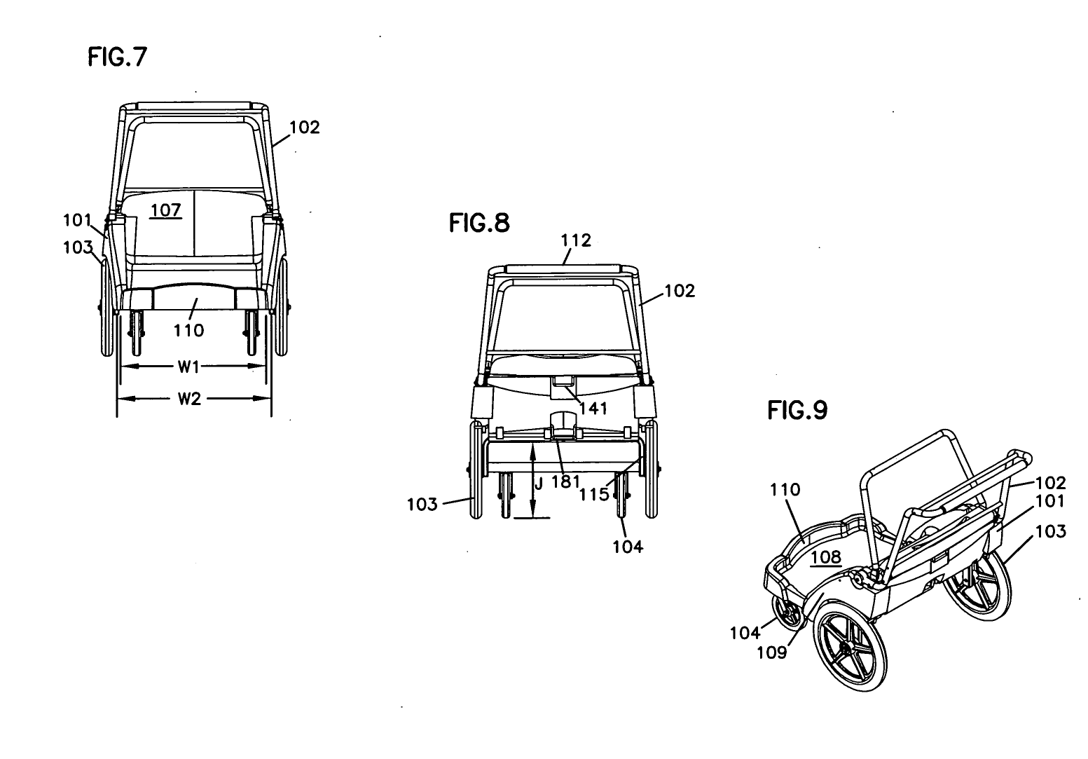

Referring now to the figures in general, FIGS. 1-9 illustrate a child stroller 100 having features that are examples of inventive aspects in accordance with the principles of the present invention. In general, the child stroller 100 is configured to transport one or more passengers. In one embodiment, the stroller 100 is sized to accommodate two average-sized children between the ages of one year and five years. In another embodiment, the stroller 100 can be designed to accommodate a single child between the ages of one year and five years. In other embodiments, however, the stroller 100 is configured to accommodate children of any desired age. Preferably, the stroller 100 is configured to accommodate and secure an infant seat in which a younger child may sit.

In the example shown in FIGS. 1-9, the stroller 100 includes a body 101 having a top side T (FIG. 2) forming a seat 106 with a backrest 107 and footrest 108. Preferably, the seat 106 and backrest 107 are arranged to support the passenger in an upright seating position. In one example embodiment, the body 101 is molded to form a single depression to accommodate a single passenger. In another example embodiment, the body 101 is molded to form two separate depressions to accommodate two passengers. In yet another embodiment, the body 101 is molded to form a bench seat 106.

In some embodiments, the body 101 has a plastic construction to enable easy cleaning of the stroller. In other embodiments, however, the body 101 can be formed of any suitable material, such as metal, rubber, or composite materials. In some embodiments, the body 101 has a height h (FIG. 26) extending from the ground to the top of the backrest 107 of about 20 inches to about 30 inches. In one example embodiment, the stroller body 101 has a height h of about 26 inches.

A handlebar assembly 102 extends from a rear R (FIG. 2) of the body 101 enabling a user to push and/or pull the stroller 100. In some embodiments, the handlebar assembly 102 includes arms extending upwardly from each side of the stroller body 101 and a grip section connecting the arms. In one embodiment, the grip section of the handlebar assembly 102 includes a comfort grip region 112 designed to provide a comfortable area for the user to interact with the handlebar assembly 102. In certain embodiments, the grip section of the handlebar assembly 102 defines the highest point of the stroller 100. In some embodiments, the stroller 100 has a height H (FIG. 2) extending from the ground to the top of the handlebar assembly 102 of from about 35 inches to about 45 inches. In one example embodiment, the stroller 100 has a height H of about 40 inches.

As best shown in FIG. 2, the body 101 also includes sides 109 and a nose 110. The sides 109 taper downwardly from the backrest 107 to the footrest 108. In the example shown, the sides 109 taper downwardly in a curved fashion. In some embodiments, the sides 109 aid in securing the child within the stroller 100. In other embodiments, the sides 109 enhance the cosmetic appeal of the stroller. The nose 110 extends upwardly from the footrest 108 at a front F of the stroller 100. The top of the nose 110 reaches a height I.

In some embodiments, the nose 110 includes a bumper (e.g., an impact edge) configured to protect the stroller 100 from minor collisions. For example, a strip of elastic material can be coupled to the nose 110. Preferably, the bumper has a thickness of about ½ inch to about ¼ inch. In other embodiments, however, the nose 110 enhances the cosmetic appearance of the stroller 100.

In some embodiments, the footrest 108, the sides 109, and the nose 110 are configured to facilitate boarding of and disembarking from the stroller 100. In one such embodiment, a pass-through area 111 separates the sides 109 from the nose 110. Passengers can board and disembark from the stroller 100 relatively unimpeded at the location of the pass-through area 111. The pass-through area 111, therefore, can be advantageous for passengers in an amusement park or similar location in which the passengers must continuously enter and exit the stroller 100 at each attraction. The pass-through area 111 also can be advantageous for young children who lack sufficient motor skills to climb easily over the sides 109 or the nose 110. In one embodiment, the pass-through area 111 is the region of the stroller 100 lowest to the ground. In another embodiment, the pass-through area 111 is substantially flat.

To facilitate movement of the body 101, a set of back wheels 103 are operably coupled to the rear R of the body 101 and a set of front wheels 104 are operably coupled to the front F of the body 101. In certain embodiments, the back wheels 103 and front wheels 104 facilitate turning of the stroller 100 and provide stability during motion. In some such embodiments, the front wheels 104 provide turning capability to the stroller 100 and the back wheels 103 provide stability. Typically, the front wheels 104 are caster wheels attached beneath the footrest 108.

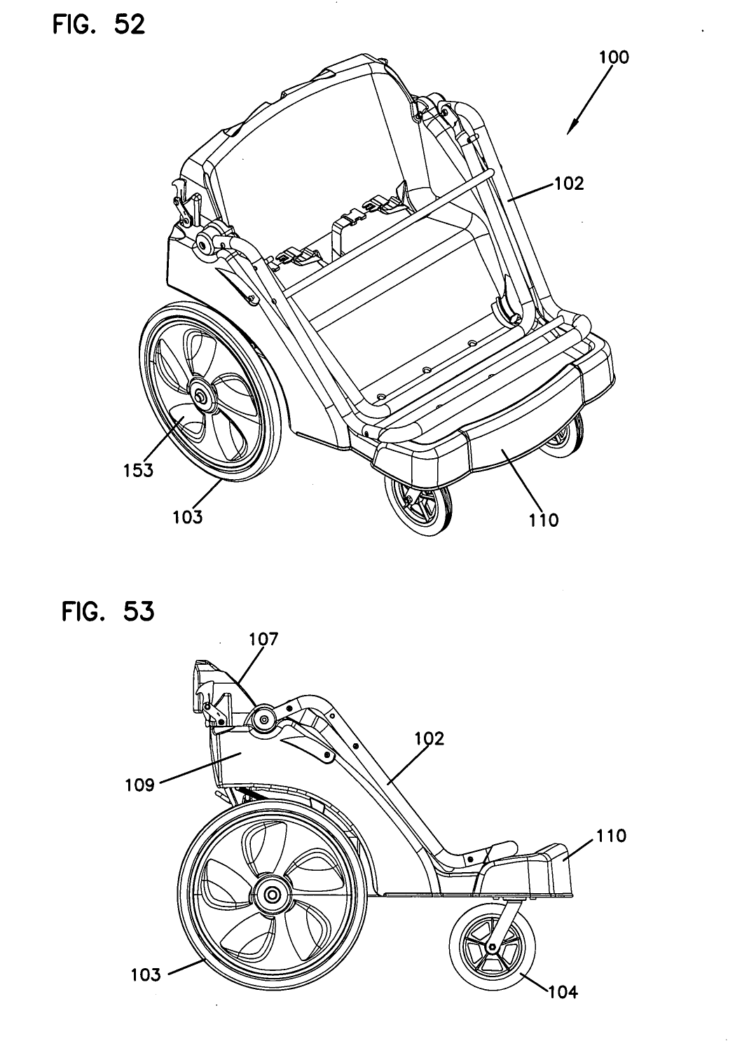

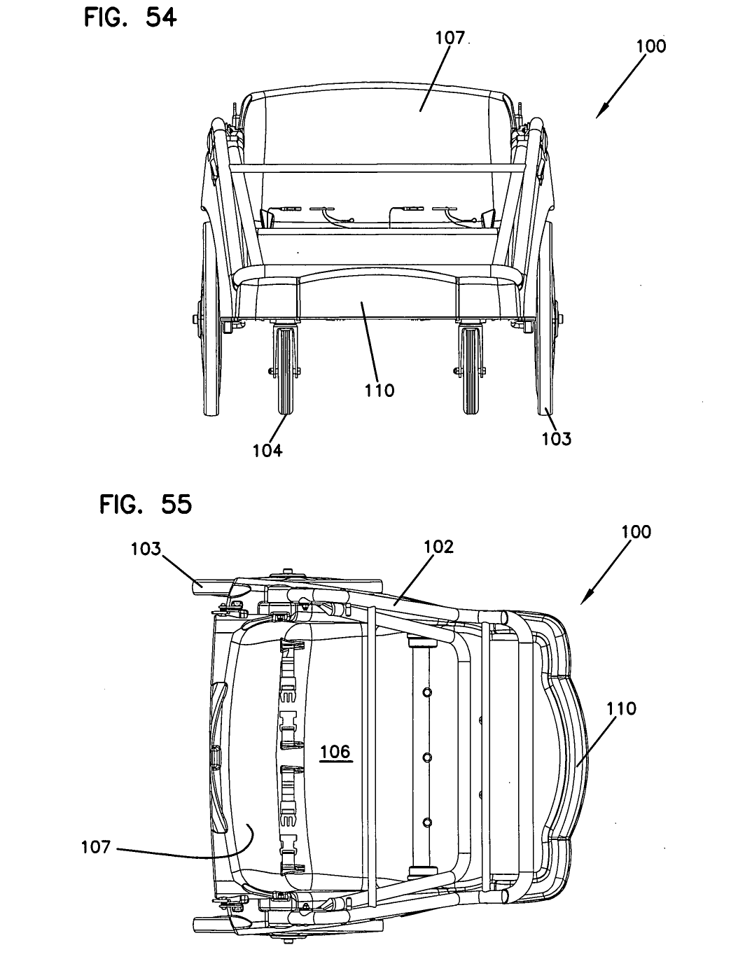

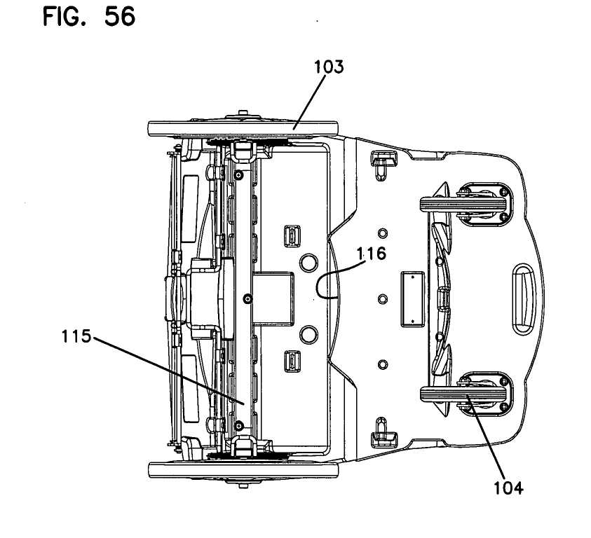

In general, the back wheels 103 are attached to an axle 115 mounted to the body 101 beneath the seat 106. Typically, the back wheels 103 are significantly larger than the front wheels 104 to provide a smoother ride. The back wheels 103 are preferably full sided with no exposed spokes. In the example shown in FIGS. 52-56, depression 153 can be made in the surfaces of the rear wheels 103 to increase the cosmetic appeal of the stroller 100. In other embodiments, spoked wheels can be used (see e.g., FIGS. 1-4).

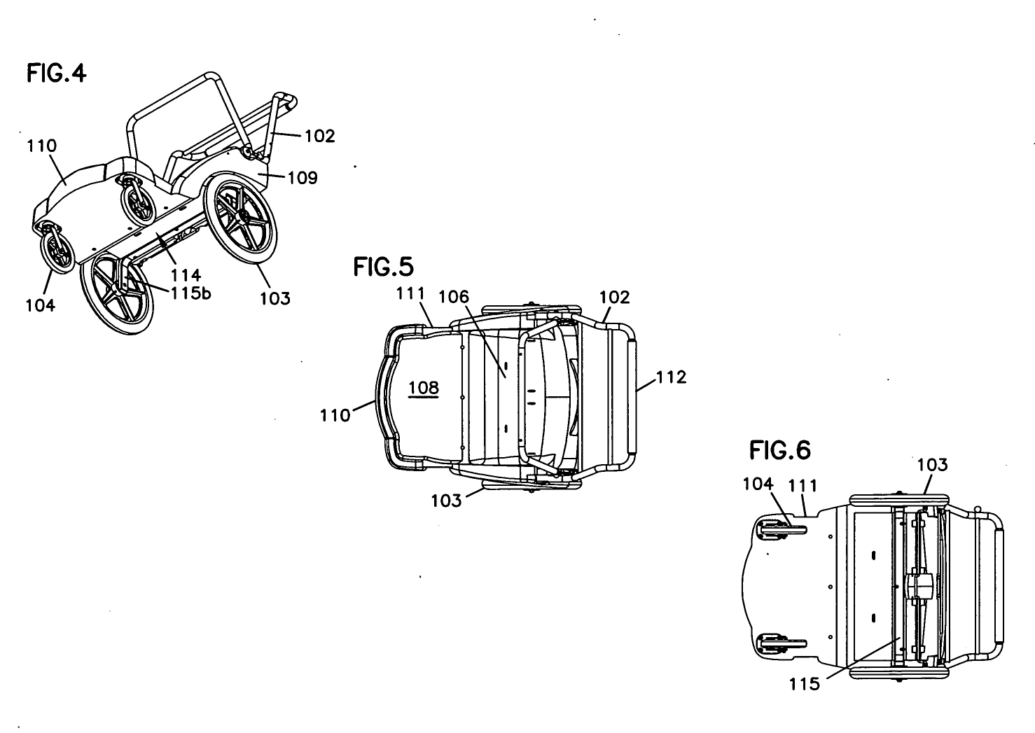

As shown in FIGS. 3 and 4, in some embodiments, a bottom side B of stroller 100 is stepped so the area beneath the seat 106 of the body 101 is raised a distance J from the ground and the area beneath the footrest 108 is raised a distance K from the ground. In one example embodiment, the front of the stroller is raised a distance K of 7.38 inches and the rear of the stroller is raised a distance J of 12.00 inches. Such a step provides a cavity 114 between the ground and the bottom side B of the rear R of the body 101. In such embodiments, the axle 115 coupling the back wheels 103 to the body 101 has a generally U-shaped design.

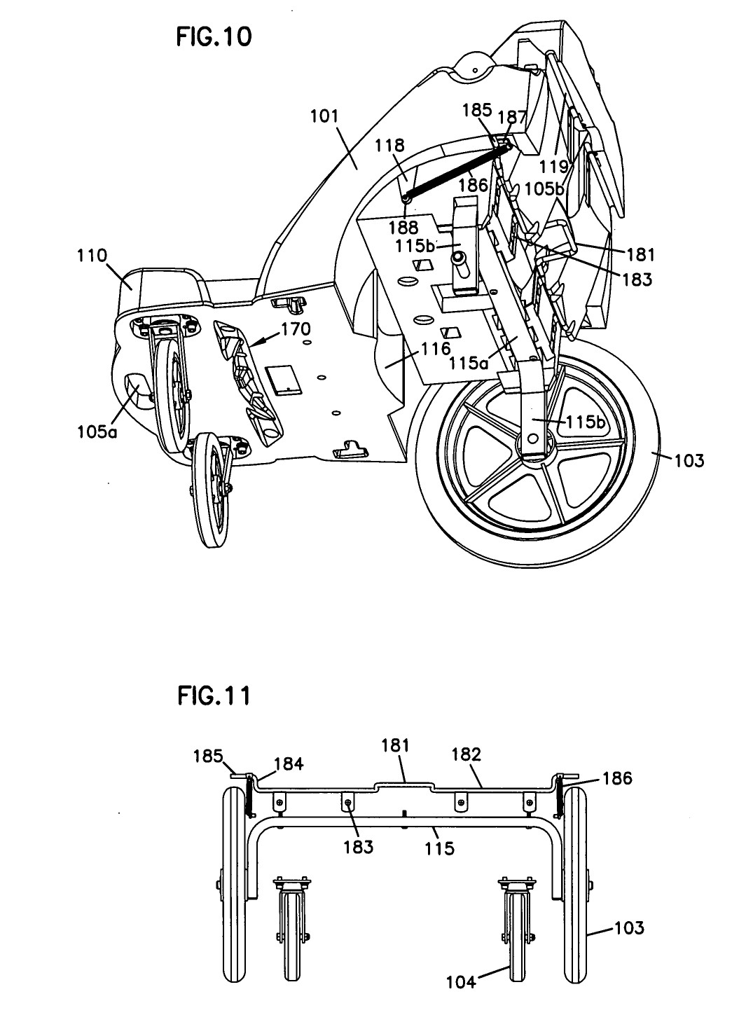

For example, in the embodiment shown in FIG. 10, the axle 115 includes an attachment section 115a, which is fixedly coupled to the bottom side B of the body 101, and flanges 115b, which extend from either side of the attachment section 115a to couple to the back wheels 103. In certain embodiments, bags, netted pouches, or other types of item storage options can be provided within the cavity 114.

Referring now to FIGS. 10-16, in certain embodiments, the stroller 100 includes a braking mechanism to selectively inhibit and enable movement of the stroller 100. In some embodiments, the braking mechanism acts on the back wheels 103 as shown in FIGS. 10-16. In other embodiments (not shown), the braking mechanism acts on both the back wheels 103 and the front wheels 104. In still other embodiments (not shown), however, the braking mechanism can act on the axle 115 and not on the wheels 103, 104.

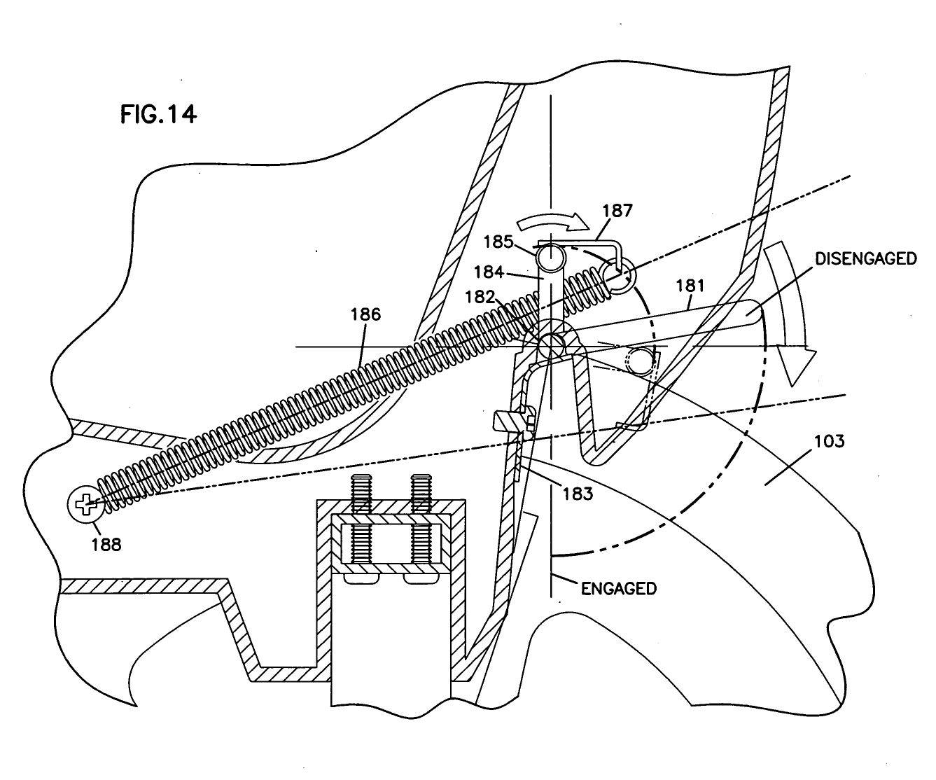

FIG. 10 is a rear bottom perspective view a stroller 100 including an example braking system 180 that acts on the back wheels 103. One of the back wheels 103 has been removed to facilitate viewing of the brake mechanism 180. The brake mechanism 180 includes a brake rod 182 rotatably secured within a nook 117 defined by a rear R of the body 101. As best seen in FIG. 14, the brake rod 182 is maintained within the nook 117 with brackets 183. The rod 182 also includes a handle 181 (FIG. 10). In the example shown, the handle 181 is U-shaped to facilitate grasping by a user. In other embodiments, however, the handle 181 can be any suitable shape.

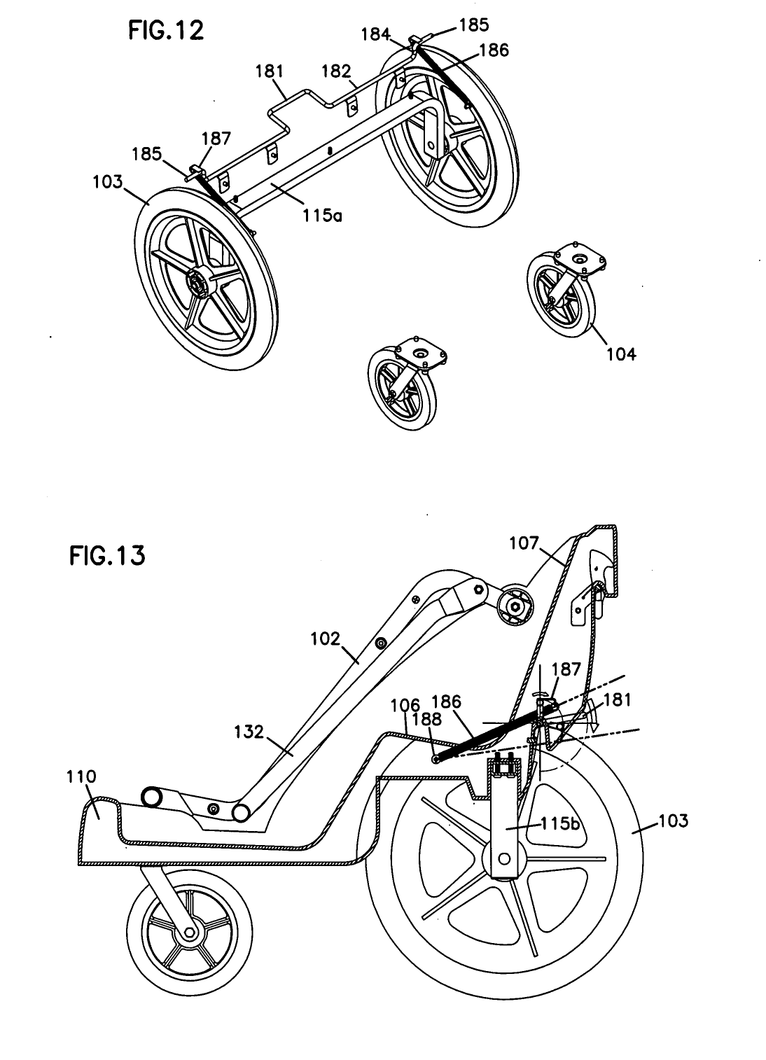

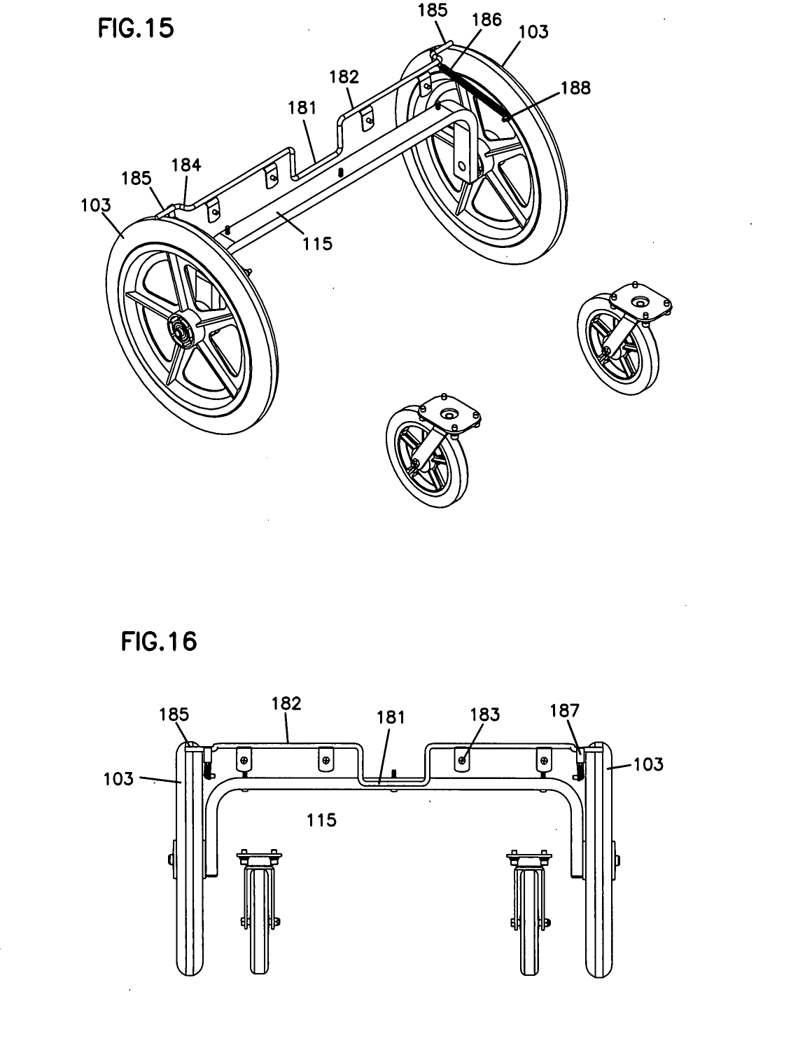

Brake tabs 185 are coupled to the brake rod 182 by flange 184 (FIGS. 11-12). The brake tabs 185 are configured to pivot from a “release position” in which the back wheels 103 can freely rotate to a “contact position” in which the back wheels 103 are inhibited from moving (FIG. 13). In the “release position,” the brake tabs 185 are raised above the back wheels 103 (FIGS. 11-12). In the “contact position,” the brake tabs 185 contact the back wheels 103 to provide frictional resistance to rotation (FIGS. 15-16). In certain embodiments, the brake tabs 185 are coated with a material to increase the friction between the tabs 185 and the wheels 103. Some examples of such a material include rubber, polyvinylchloride, and other such materials. In one embodiment, the brake rod 182, flange 184, and brake tabs 185 are monolithically constructed by bending either end of the brake rod 182.

Each brake tab 185 is coupled to a spring 186 at one end by a coupler flange 187 (FIG. 14). In some embodiments, the coupler flanges 187 are generally L-shaped flanges that protrude rearwardly from the brake tabs 185 when the brake tabs 185 are maintained in the “release position.” In other embodiments, the coupler flanges 187 can be any suitable shape to couple the springs 186 to the brake tabs 185. The opposite ends of the springs 186 are secured to the stroller body 101 at a point 188. In the example shown in FIG. 10, the opposite ends of the springs 186 are secured to a mounting flange 118 extending downwardly from the body 101. The springs 186 tension the brake tabs 185 towards the point 188. In the “contact position,” the springs 186 maintain the brake tabs 185 firmly against the back wheels 103.

In use, to brake the stroller 100, a user grasps the handle 181 and rotates the handle 181 downwardly from a “disengaged position” to an “engaged position” (FIGS. 13-14). Rotating the handle 181 rotates the brake tabs 185 from the “release position” to the “contact position.” The springs 186 maintain the brake tabs 185 against the back wheels 103 to provide frictional resistance to movement of the back wheels 103. To enable movement of the stroller 100, the user rotates the handle 181 upwardly back to the “disengaged position” to raise the brake tabs 185 off of the back wheels 103. The springs 186 maintain the brake tabs 185 in the release position.

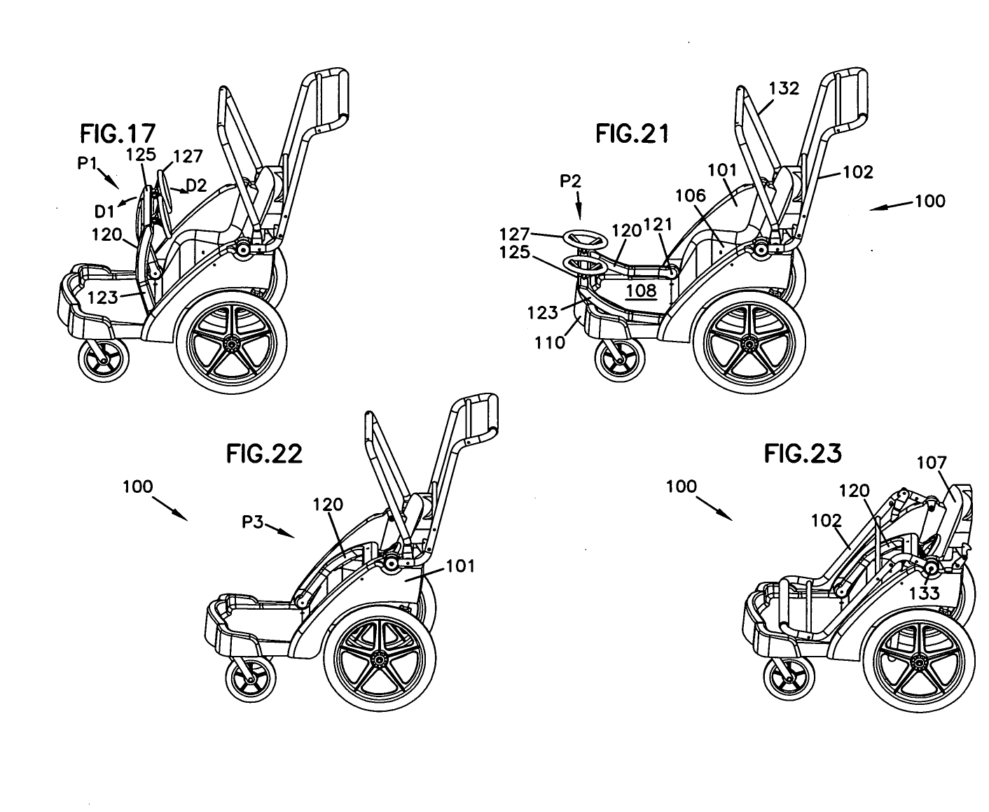

Referring now to FIGS. 17-23, certain embodiments of the stroller 100 can include one or more activity bars 120. An activity bar 120 is generally designed to provide one or more diversions for the stroller passengers. In some embodiments, the activity bar 120 includes a main region 125 extending laterally across the stroller 100. The main region 125 is coupled to the body 101 of the stroller 100 by one or more arms 123. In the embodiment shown in FIG. 17, opposing ends of the main region 125 of an activity bar 120 are coupled to the body 101 by arms 123.

In some embodiments, the main region 125 of each activity bar 120 includes one or more hand toys with which passengers may play. In one embodiment, the main region 125 includes one or more mock steering wheels 127 with which the passengers can amuse themselves. In another embodiment, the main region 125 can include horns, bells, or other noise-making toys. In other embodiments, the main region 125 can include electronic devices such as radios, display screens, video game consoles, and/or recorded media players (not shown). In still other embodiments, the main region 125 can include organization or storage areas. For example, in one embodiment, the main region 125 can include cup holders (not shown). In another embodiment, the main region 125 can include pegs, clips, or other fasteners to which bags or other items can be attached (not shown).

In some embodiments (not shown), the activity bar 120 is removably coupled to the stroller 100. In such embodiments, an activity bar 120 of one type can be substituted for an activity bar 120 of another type to suit the interests of each passenger. For example, an activity bar 120 including a steering wheel 127 may come stock with a stroller 100 and can be switched with an activity bar 120 including a video game (not shown) when or after the stroller 100 is acquired. Such versatility can increase the utility and appeal of the stroller 100. When strollers 100 are rented from commercial establishments, an extra fee can be paid to upgrade the stroller activity bar 120.

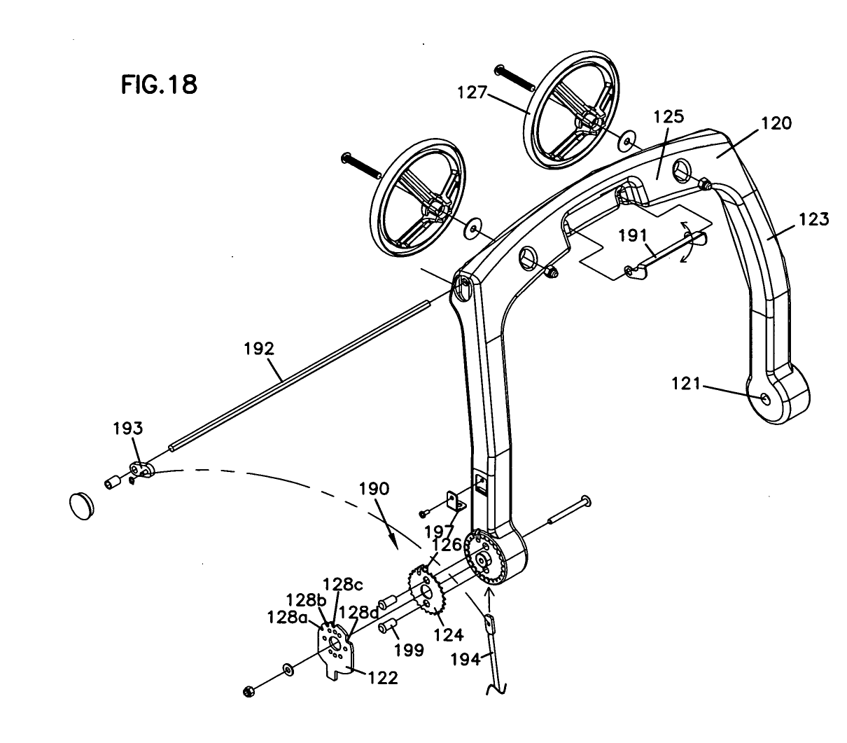

In certain embodiments, the activity bar 120 can be pivotably attached to the body 101 of the stroller 100. For example, the activity bar 120 can be designed to shift positions from a “loading” position, to at least one “in use” position, to a “storage” position. FIGS. 18-20 illustrate an example latching system 190 configured to enable the activity bar 120 to pivot and lock into such predetermined positions.

The latching system 190 includes a handle 191 attached to a rotatable rod 192 extending within the main area 125 of the activity bar 120. In the example shown, the rod 192 has a transverse cross-section shaped like a hexagram. At least one end of the rotatable rod 192 couples to a lift rod 194 via a lift cam 193. The lift rod 194 extends from the rotatable rod 192 through one of the arms 123 of the activity bar 125. As shown in FIG. 20, the lift rod 194 includes a bent leg 195 configured to lock into a guide plate 124 and an index plate 122. A spring 196 biases the lift rod 194 into locking engagement with the plates 122, 124.

The guide plate 124 is configured to rotate with the activity bar 120. In certain embodiments, the guide plate 124 includes an arrangement that keys into the arm 123 of the activity bar 120. In the example shown, the arrangement includes teeth and notches. The guide plate 124 includes a flange arrangement 126. The bent leg 195 of the lift rod 194 is configured to sit within the flange arrangement 126 to inhibit rotational play in the latch system 190.

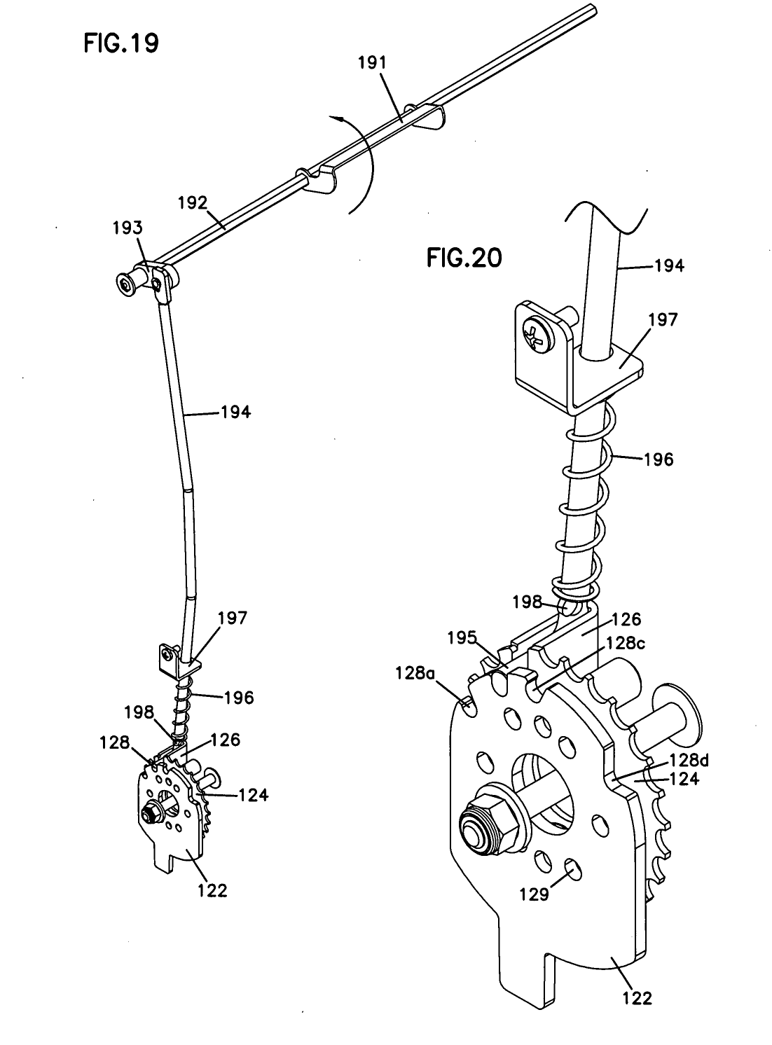

The index plate 122 is fixed to the stroller body 101 and cannot pivot or otherwise move with the activity bar 120. The index plate 122 includes at least three latching points 128 at which the bent leg 195 of a lift rod 194 can interlock with the index plate 122. For example, the index plate 122 shown in FIGS. 19-20 includes a “storage” latching point 128a, a first “in use” latching point 128b, a second “in use” latching point 128c, and a “loading” latching point 128d.

The index plate 122 also includes a series of through holes 129 (FIG. 20) adapted to interface with one or more spring-loaded ball plungers 199 (FIG. 18). The ball plungers 199 are configured to provide movement resistance and to aid in centering the lift rod 194 prior to engagement with one of the latching points 128. The ball plungers 199 can also provide audible feedback when latching occurs.

In use, a user engages (e.g., rotates, lifts, or presses) the handle 191 to rotate the rod 192 to pivot the lift cam 193 upwardly. Pivoting the lift cam 193 raises the lift rod 194 within the arm 123 of the activity bar 120 against the bias of the spring 196. The spring 196 compresses against a guide tab 197 coupled to the arm 123. Raising the lift rod 194 disengages the bent leg 195 from its original latching point 128. The user can then pivot the activity bar 120 until the bent leg 195 aligns with a desired latching point 128. Releasing the handle 191 lowers the lift rod 194 and enables the spring 196 to bias the bent leg 195 into the desired latching point 128.

In certain embodiments, spring-biased lift rods of the type described above extend from both ends of the rotatable rod 192. In such embodiments, matching index plates 122 couple to both sides of the stroller 100 adjacent where the arms 123 couple to the stroller body 101. Rotating the handle 191 operates both lift rods as described above.

Pivotable attachment of the activity bar 120 can facilitate loading and unloading of passengers. The activity bar 120 shown in FIG. 21 is configured to pivot about a generally horizontal axis 121 in a first direction D1 (FIG. 17) from an “in use” position P1 (FIG. 17) to a “loading” position P2 (FIG. 21). When in the “loading” position, the main region 125 rests adjacent the nose 110 and the arms 123 rest adjacent the footrest 108. Such a position facilitates clambering over the activity bar 120 to reach the seat 106.

Pivotable attachment of the activity bar 120 can also enable the stroller 100 to accommodate passengers of different sizes. For example, an activity bar 120 can be configured to shift (e.g., pivot) from a first “in use” position, providing sufficient legroom and arm room for larger passengers, to a second “in use” position closer to the seat 106 to enable smaller passengers to reach the activities provided on the main region 125. FIG. 20 illustrates part of the latching system 190 of a stroller having an activity bar 120 in the second “in use” position. To pivot the activity bar 120 to the first “in use” position, the handle 191 is engaged to lift the bent leg 195 of the lift rod 194 out of the latching point 128b. After pivoting the activity bar 120 away from the seat 106 to the desired position, the handle 191 is released to drop the bent leg 195 into the latching point 128c.

The activity bar 120 is also designed to facilitate storage and group-transport of the strollers 100 by pivoting about the generally horizontal axis 121 to a “storage” position P3 (FIG. 22). Collapsing the activity bar 120 against the seat 106 lowers the height of the front F of the stroller 100. Collapsing the activity bar 120 also facilitate collapsing the handlebar assembly 102 as shown in FIG. 23.

In another embodiment (not shown), only one arm 123 extends from the main region 125 to the stroller body 101. Two such activity bars can be provided on the stroller 100. For example, an arm of a first activity bar can couple to one side of the stroller and an arm of a second activity bar can couple to the opposite side of the stroller. Such a configuration enables the arm of the first activity bar to be positioned to accommodate a larger passenger (e.g., a five year old child) while the arm of a second activity bar is positioned to accommodate a smaller passenger (e.g., a two year old child).

In still other embodiments (not shown), the activity bar 120 may be configured to pivot about a generally vertical axis (not shown) outwardly from the interior of the stroller 100. For example, in one such embodiment, an activity bar is coupled to the body of a stroller by only one arm, and rotating the arm about the generally vertical axis translates the main region of the activity bar to protrude outwardly from the stroller 100. In other embodiments, however, the activity bar 120 includes a quick release mechanism (not shown) to facilitate quickly removing the activity bar 120 from the body 101 of the stroller 100. Removing the activity bar 120 both facilitates entry and exit from the stroller 100 and enables the stroller 100 to accommodate larger passengers.

Referring now to FIGS. 23-28, the handlebar assembly 102 of the stroller 100 can collapse downwardly as well. In some embodiments, the handlebar assembly 102 pivots about the generally horizontal axis 133 so that the arms of the handlebar assembly 102 extend along sides 109 and the grip portion 112 of the handlebar assembly 102 extends adjacent the footrest 108. In one such embodiment, the ends of the grip section 112 rest against the front nose 110. In certain embodiments, a canopy support bar 132, hereinafter discussed, folds forwardly with the handlebar assembly 102.

One example of a stroller 100 having a collapsed handlebar assembly 102 is shown in FIGS. 52-56. Preferably, the handlebar assembly 102 fits within the outer bodyline of the stroller 100 when collapsed. Fitting the handlebar assembly 102 within the body 101 of the stroller enables the stroller 100 to fully nest behind another stroller, which will be discussed in more detail herein.

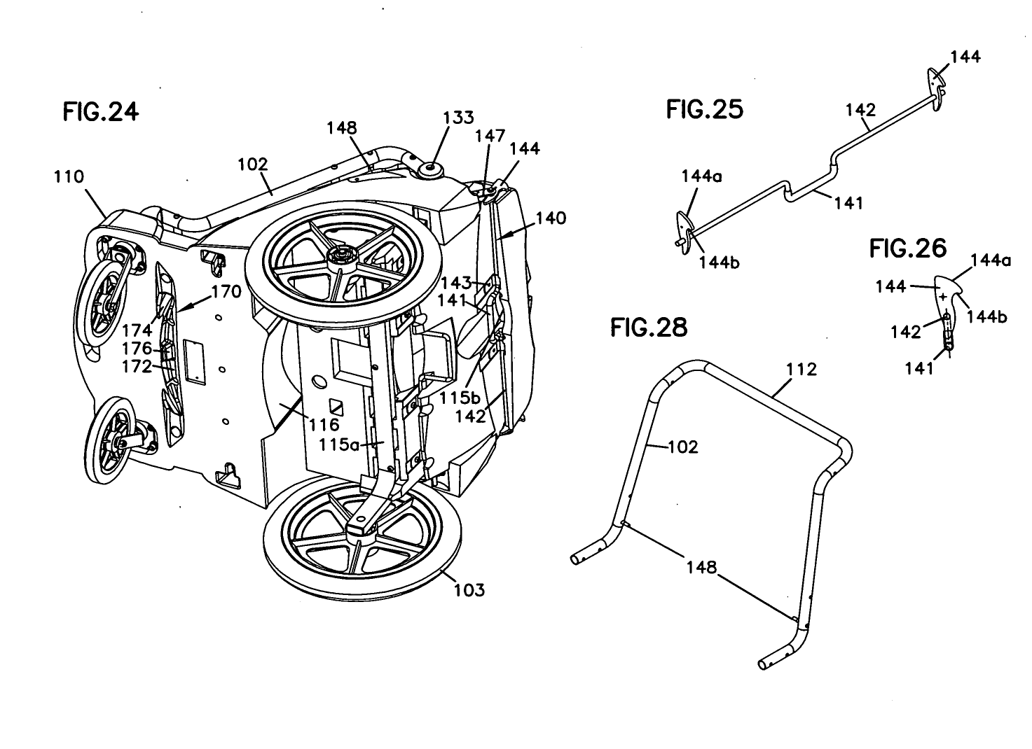

In certain embodiments, a user collapses the handlebar assembly 102 using a latching system 140. In the example shown in FIGS. 24-28, the user manipulates the latching system 140 through a handle 141 coupled to a rod 142 extending through a nook 119 (FIG. 10) on the rear R of the stroller body 101. The rod 142 is rotatably mounted within the nook 119 using brackets 143 (FIG. 24). In some embodiments, the handle 141 is shaped to facilitate grasping by the user. In the example shown in FIGS. 24-25, the handle 141 is U-shaped. In other embodiments, the handle 141 can be any suitable shape capable of being grabbed by the user. In one embodiment, the handle 141 is coated with a material, for example with polyvinylchloride, to provide a comfortable grip to the user.

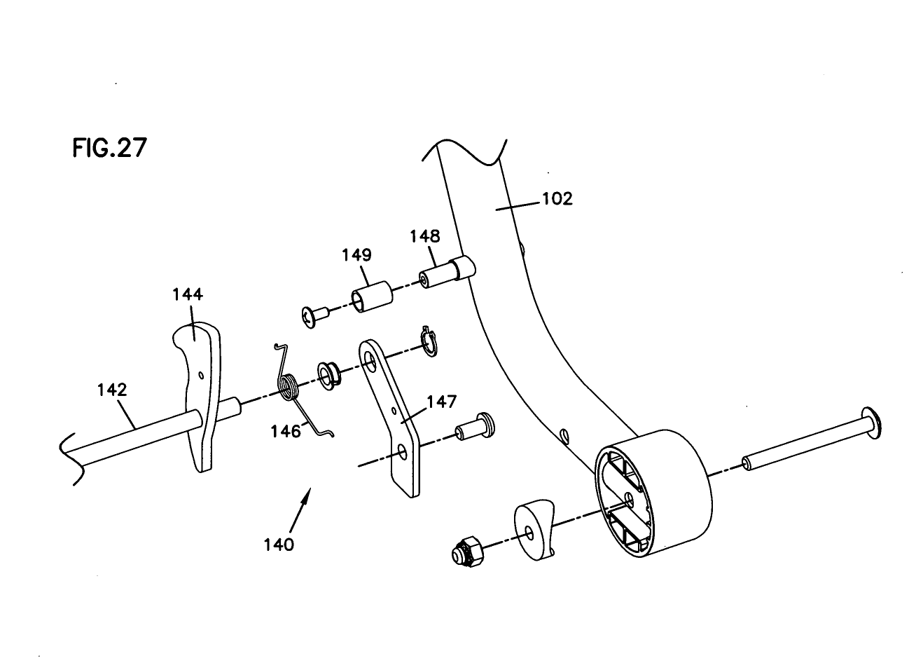

At least one end of the latching system rod 142 couples to a latch 144 such that rotating the rod 142 rotates the latch 144 from a first position to a second position (FIG. 25). As best shown in FIG. 26, each latch 144 includes a camming surface 144a and a catch surface 144b. Each latch 144 is biased into the first position by a spring 146 against a flange 147 fixedly coupled to the body 101 (FIG. 27). In the example shown, torsion springs 146 bias the latches 144 on either end of the latching system rod 142. In other embodiments, however, any suitable spring can be used to bias each latch 144 into a first position.

As best shown in FIG. 28, the handlebar assembly 102 includes at least one pin 148 protruding inwardly from the handlebar assembly 102. The example handlebar assembly 102 shown in FIG. 28 includes two pins 148 protruding from opposite sides of the handlebar assembly 102. In certain embodiments, roller sleeves 149 mount over each pin 148 to protect the pin 148 and to facilitate latching. In one such embodiment, the roller sleeves 149 are nylon roller sleeves slip-fit over the pins 148.

In use, the handlebar assembly 102 is locked into an upright position by rotating the handlebar assembly 102 about point 133 until each pin 148 slides over the camming surface 144a of each latch 144 and is captured by the catch surface 144b. The spring 146 biases each latch 144 to the first position to maintain the handlebar assembly 102 is an upright position. To collapse the handlebar assembly 102, a user grasps and rotates the handle 141 to rotate the latches 144 against the bias of the spring 146 to the second position. When the latches 144 are sufficiently rotated, the pins 148 are released by the camming surface 144b and the handlebar assembly 102 can be folded forward by the user.

Referring now to FIGS. 29-32, multiple strollers 100 can horizontally nest into one another to facilitate storage and group transport. As the term is used herein, nesting refers to arranging the strollers so that at least a portion of one stroller overlaps at least a portion of another stroller, thereby reducing the combined footprint of both strollers. Advantageously, nesting the strollers 100 generally decreases the amount of area occupied by a group 200 of strollers 100. Nesting can also enable entrainment of the strollers 100 so that a group of 200 strollers 100 can be transported by acting on one of the strollers 100 in the group 200.

Nesting is generally accomplished by sliding a front of a second stroller into the cavity at the rear of a first stroller. The front of any subsequent nesting stroller is similarly slid into the rear of the preceding nesting stroller. As shown in FIG. 29, in general, the front F of each stroller 100 tapers inwardly and downwardly from the rear R of the stroller 100 such that a width W1 of the front F of the stroller 100 is less than a width W2 of the cavity 114 of the stroller 100 (FIG. 29). The front F of the stroller 100, however, remains sufficiently wide to maintain stability when in use.

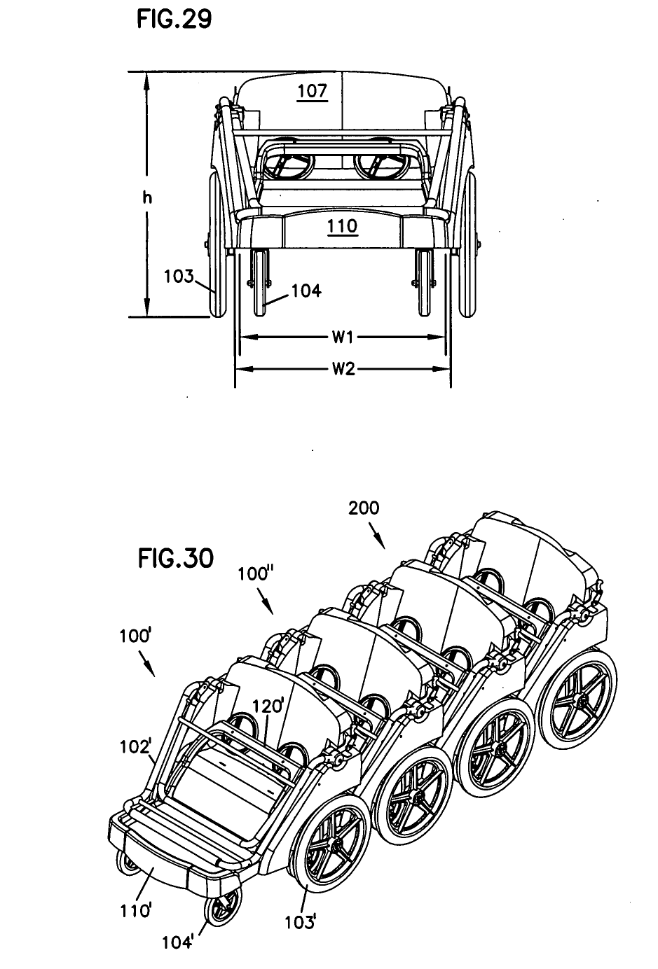

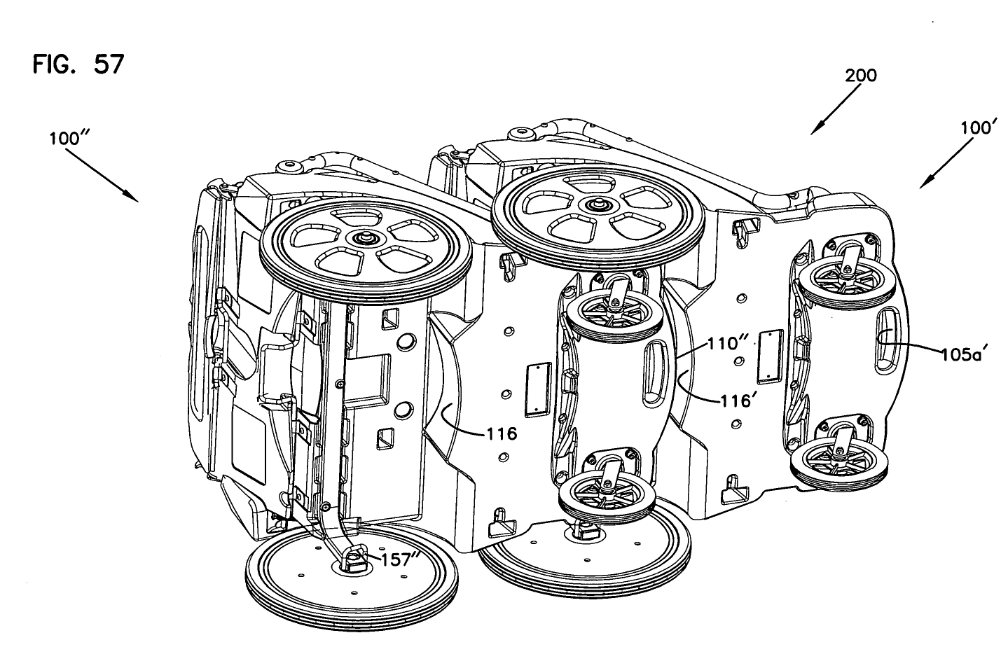

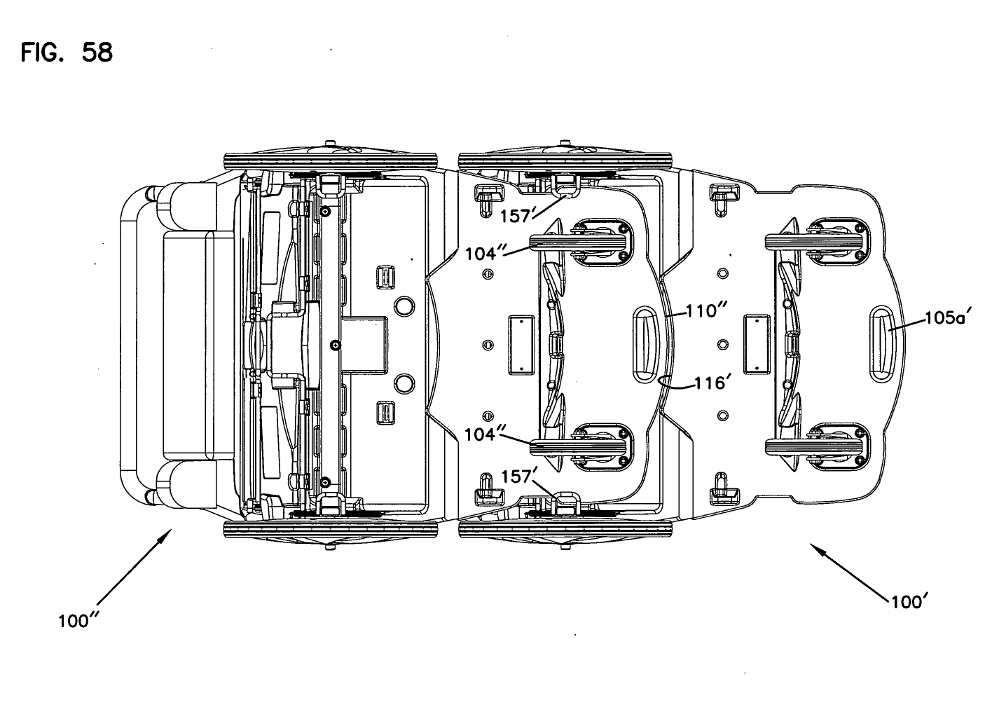

FIGS. 30-32 illustrate a group 200 of nested strollers 100. This disclosure refers to the first stroller in such a group as 100′ and any subsequently nested stroller as 100″. In some embodiments, the nose 110″ and the front wheels 104″ of a nesting stroller 100″ are slid into the cavity 114′ of a first stroller 100′. In certain embodiments, the stroller bodies 101 include a groove or recess 116 (FIG. 24) configured to accept the nose 110″ of a nesting stroller 100″. FIGS. 57 and 58 illustrate one example rearward stroller 100″ nested behind one example forward stroller 100′. The nose 110″ of the rearward stroller 100″ contacts the groove 116′ of the forward stroller 100′.

In the embodiment shown in FIGS. 30-32, three strollers 100″ are nested behind the first stroller 100′. The activity bars 120′, 120″ and handlebar assemblies 102′, 102″ of the first stroller 100′ and the nesting strollers 100″, respectively, have been collapsed. In certain embodiments, the handlebar assemblies of each stroller taper inwardly as they extend upwardly (see, e.g., FIGS. 5-8). In one such embodiment, a top portion of the handlebar assembly 102″ of each nested stroller 100″ also slides into the cavity 114′ of the preceding stroller 100′.

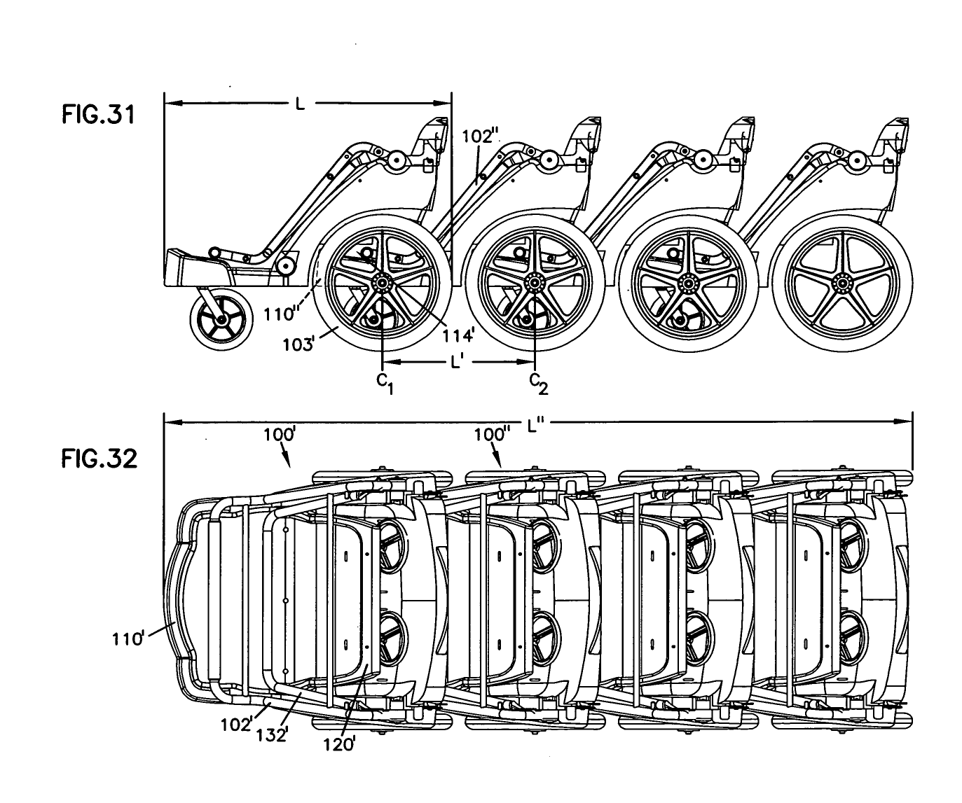

In general, nesting decreases the amount of area occupied by a group 200 of strollers 100. For example, a stroller 100 extends along a length L from a front portion of the nose 110 to a rear portion of the back wheels 103 (FIG. 31). If the strollers in a group 200 could not nest, then arranging a group 200 of N strollers in a front F to rear R configuration would yield a group length L″ (FIG. 32) of about (N·L). In contrast, a length L′ (FIG. 31) of each nested stroller (i.e., the footprint occupied by each nested stroller) can be measured from a center point C₁ of the back wheel of the immediately proceeding stroller, such as the back wheels 103′ of the first stroller 100′, to the center point C₂ of the back wheel of the nested stroller, such as the back wheels 103″ of the second stroller 100″. Each additional nested stroller 100″ will increase the length L″ of the group 200 by the length L′ instead of by the length L. The total length L″ of the group 200 of N nested strollers arranged in a front to rear configuration, therefore, is about (L+((N−1)·L′)).

In general, the length L′ is less than the length L. Typically, the length L′ is significantly less than the length L. In some embodiments, the length L′ is about the diameter of the back wheel 103 of a stroller 100. In other embodiments, the length L′ has a range of about 28 inches to about 36 inches. For example, in one such embodiment, a single stroller 100 has a length L equal to about 32 inches. A group 200 of four such unnested strollers, therefore, will have a length L″ of about 128 inches (i.e., 4·32=128). However, nesting the group 200 provides a length L′ of each nested stroller of about 17 inches. A group 200 of four such nested strollers, therefore, will yield an overall length L″ of about 71 inches (i.e., 32+(3·17)=71).

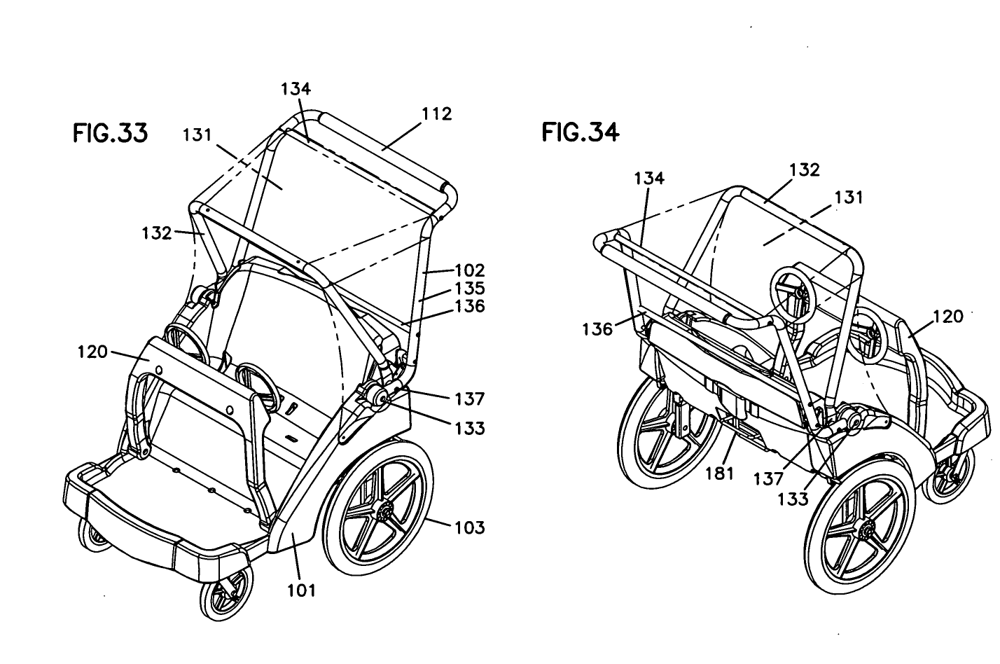

Referring now to FIGS. 33-36, in some embodiments, a stroller 100 can include a canopy 130 to provide passengers protection from sun, rain, or other environmental conditions. A canopy 130 can also increase the cosmetic appeal of the stroller 100. In some embodiments, the canopy 130 can also provide storage for items.

In general, the canopy 130 includes fabric 131, netting, or other suitable material arranged over a frame 135. In some embodiments, the frame 135 includes the handlebar assembly 102 and a canopy support bar 132. In one embodiment, the handlebar assembly 102 also includes a first canopy support rod 134 and a second canopy support rod 136 extending between the arms of the handlebar assembly 102. In the example shown, the canopy support bar 132 extends from the handlebar assembly 102 at a point 137. In other embodiments, however, the canopy support bar 132 can extend from the body 101 of the stroller 100 adjacent the point 133 from which the arms of the handlebar assembly 102 extend.

As shown in FIGS. 33-34, in one embodiment, the fabric 131 forming the top of the canopy 130 extends between the first support rod 134 and the support bar 132. The fabric 131 forming the rear bottom portion of the canopy 130 attaches to the second support rod 136 and the fabric 131 forming the front bottom portion attaches to the body 101 of the stroller 100. In another embodiment, the fabric 131 attaches only to the frame 135 and not to the stroller body 101. In other embodiments, however, the netting or other material 131 is secured over the frame 135 and/or stroller body 101 in any suitable arrangement.

In some embodiments, the frame 135 of the canopy 130 can be moved into different positions. In one example embodiment, the support bar 132 can be pivoted at a point of rotation 137 to shift towards the handlebar assembly 102 (not shown). Pivoting the support bar 132 in such a manner folds back the fabric 131 and provides the stroller passengers with an unobstructed view of the surrounding areas. In another example embodiment, both the support bar 132 and the handlebar assembly 102 can be folded forwardly to a “collapsed” position against the seat 106 (see FIG. 23). Preferably, the support bar 132 and the handlebar assembly 102 collapse completely within the outer edge of the body 101 of the stroller 100 and the fabric 131 of the canopy 130 folds flat against the body 101 to be contained fully within the body 101 as well.

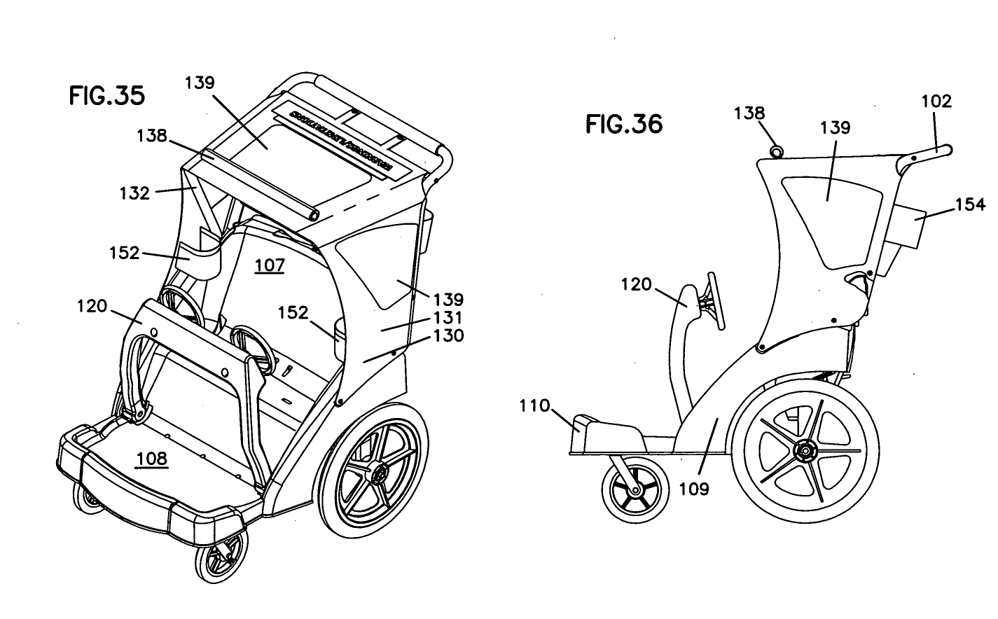

In some embodiments, the canopy 130 includes windows 139 (see FIGS. 35-36) that enable passengers to view the environment around the stroller 100. In one embodiment, side windows 139 are formed from a material through which a passenger can view the surroundings. Examples of such material can include netting, clear plastic, or any other suitable material allowing sufficient light to pass through to enable visibility. In another embodiment, the windows are formed from voids in the fabric 131 forming the canopy 130.

Also shown in FIGS. 35-36 is a sunroof-type window 139 formed by folding back a loose flap of material 138 on top of the canopy 130. The same type of material forming the side windows can also form the sunroof-type window. In another embodiment, folding back (e.g., rolling) the canopy flap 138 forms a void in the top of the canopy 130. Preferably, the canopy flap 138 is rolled towards the front F of the stroller 100 (FIG. 35). In certain embodiments, the flap 138 can be folded over the front edge of the canopy 130 to block sunlight from the front of the canopy 130. In other embodiments, the flap 138 can be folded/rolled rearwardly.

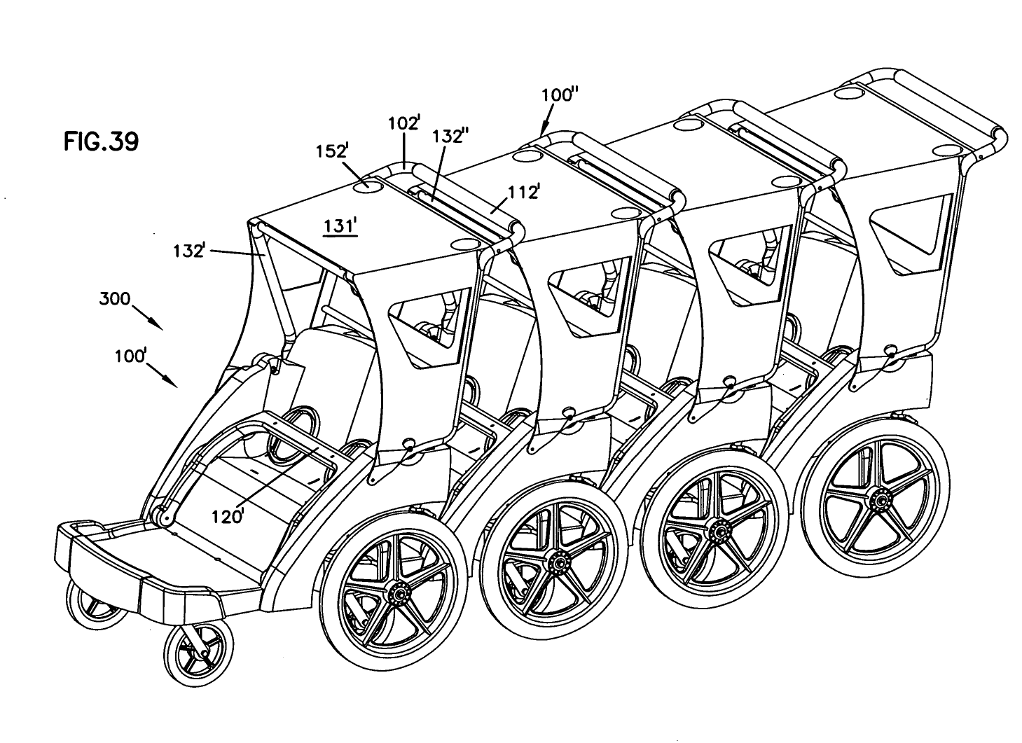

In some embodiments, the canopy 130 provides a variety of options for storing various items on the stroller 100 during use. In one example embodiment, the canopy frame 135 and material 131 have sufficient strength and stability to hold a package or other item placed on top of the canopy 130. In certain example embodiment, cup holders are provided on the canopy. For example, in the embodiment shown in FIG. 35, cup holders 152 are provided on the inner side surfaces of the canopy 130. In the embodiment shown in FIG. 39, however, cup holders 152′ are provided in the top of the canopy 130.

In other embodiments, storage pouches can be provided on the canopy 130. In certain embodiments, the storage pouches are sized to hold books, stuffed animals, purses, and other similarly sized items. In one embodiment, storage pouch 154 is provided on the canopy 130. In one embodiment, a storage pouch 154 is provided on the back outer surface of the canopy 130 (FIG. 35). In another embodiments (not shown), a storage pouch can be provided in the cavity 114 for storing items. In one such embodiment, the storage pouch can be formed from netting or other such material suspended from the stroller body 101. Such a storage pouch, when empty, would be configured to not interfere with nesting of the stroller 100.

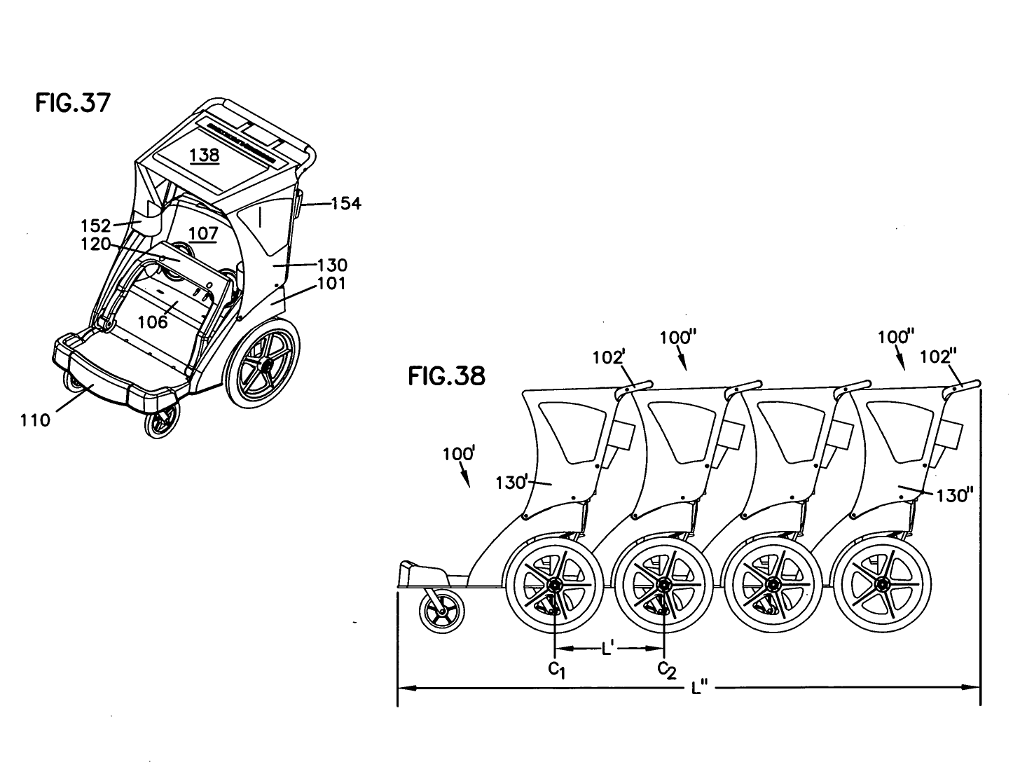

Referring now to FIGS. 37-39, horizontal nesting of strollers 100 having canopies 130 can be accomplished in either the “canopy down” configuration, as shown in FIGS. 30-32, or in a “canopy up” configuration, as shown in FIGS. 38-39. In the “canopy down” nesting configuration, the handlebar assembly 102 and the support bar 132 are collapsed as discussed above. In one embodiment, the fabric 131 of the canopy 130 is sufficiently flexible to enable folding of the bars 102, 132 without interference. In another embodiment, the fabric 131 is removed prior to collapsing the bars 102, 132. In the “canopy up” nesting configuration, the activity bar 120, if present, is collapsed and the frame 135 is maintained in the upright position as shown in FIG. 37. Typically, the canopy fabric 131 is left attached to the frame 135.

FIGS. 38-39 illustrate a group 300 of four strollers 100 nested in a “canopy up” configuration. In the “canopy up” configuration, as in the “canopy down” configuration, the front of each subsequently nested stroller is slid into the cavity of the preceding stroller. The canopy frame 135, however, is positioned in the upright position, as shown in FIG. 37, rather than in the collapsed position, as shown in FIG. 23. In some embodiments, the group 300 of strollers 100 nested in a “canopy up” configuration will have substantially the same length L″ as a group 200 of the same strollers 100 nested in a “canopy down” configuration. In some such embodiments, the handlebar assemblies of each nesting stroller are configured to enable the canopy support bar of the subsequent stroller, such as support bar 132″, to fit underneath the grip section of the handlebar assembly of the forward stroller, such as the grip section 112′ of the handlebar assembly 102′ of stroller 100′ (FIG. 38). In certain embodiments, however, the erect handlebar assemblies 102″ of the last stroller 100″ in the group 300 will add a few inches (e.g., about 3-10 inches) to the group length.

In other embodiments, the group 300 of strollers 100 nested in the “canopy up” configuration is in general not as densely packed together as the group 200 of strollers 100 nested in the “canopy down” configuration. For example, in one such embodiment, the forwardly jutting support bar of each nested stroller, such as support bar 132″ of stroller 100″, contacts the handlebar assembly of the preceding stroller, such as the handlebar assembly 102′ of stroller 100′ preventing the strollers 100 from fully nesting. In such embodiments, a group 300 of strollers nested in a “canopy up” configuration will have a longer length L″ than a group 200 of strollers nested in a nested in a “canopy down” configuration.

For example, in one embodiment, the distance L′ between the center point C₁′ of the back wheels 103′ of a first “canopy up” nested stroller 100′ and the center point C₂′ of the back wheels 103″ of a second “canopy up” nested stroller 100″ is about 19 inches. The erect handlebar assembly 102″ adds about 7 inches to the length of the last stroller 100″. A group 300 of four such “canopy up” nested strollers, therefore, has a length L″ of about 96 inches (i.e., 32+7+(3×19)=96).

Advantageously, nesting can enable better management of groups of strollers. For example, groups 200, 300 of nested strollers 100 can be pushed and directed to a storage area as one unit, rather than gathering each of the strollers 100 one by one. In certain embodiments (not shown), nested strollers can be secured together to enable movement of one stroller to entrain the remaining strollers. For example, in one such embodiment, each stroller 100 includes a protrusion on the front F and a slot/hole defined adjacent the rear R of the stroller body 101 (not shown). When the front F of a stroller is pushed into the cavity 114 of a preceding stroller, the protrusion can be hooked/latched into the slot. In another such embodiment, a physical coupler device (not shown) can secure the strollers 100 together. Such a coupler device can be readily made by one having skill in the art.

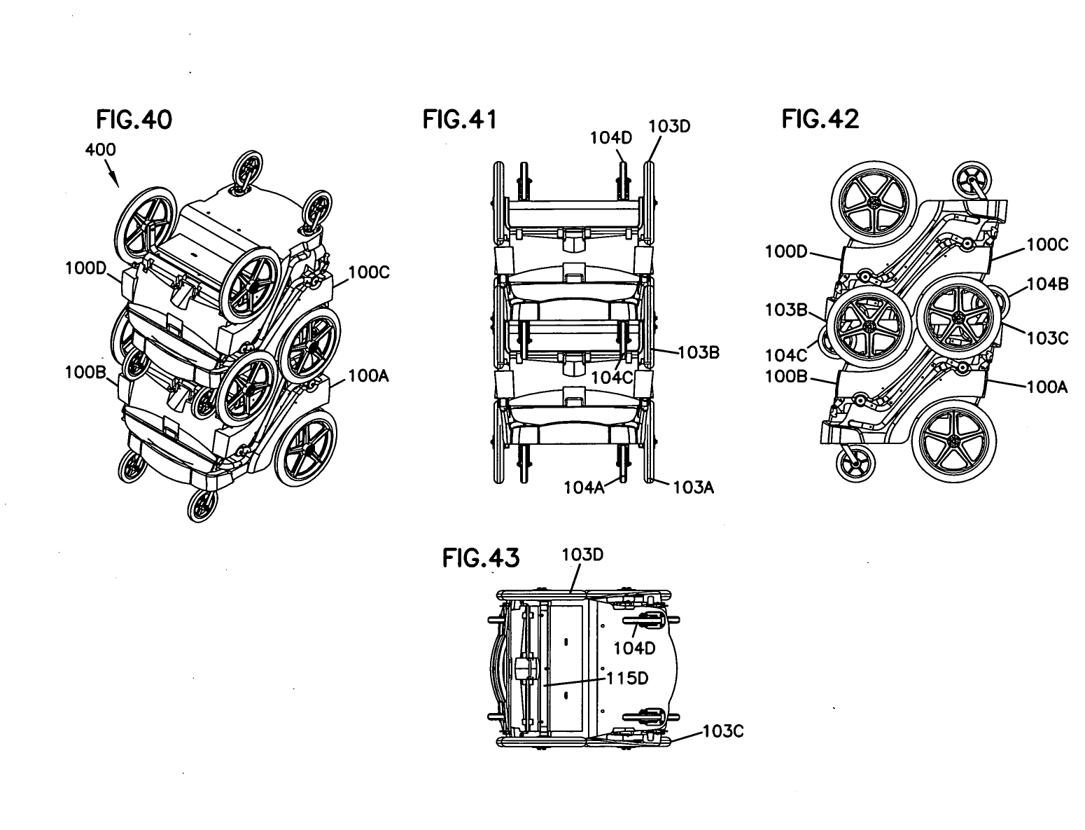

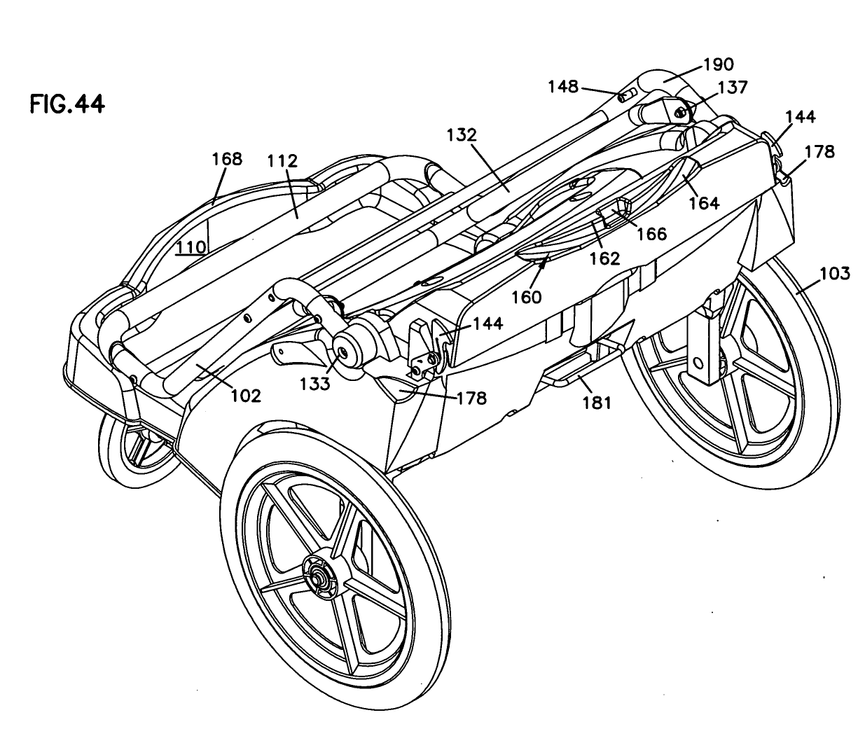

Referring now to FIGS. 40-45, in certain embodiments, strollers 100 can be vertically stacked to conserve storage space. As the term is used herein, vertical stacking refers to piling at least one stroller on top of another such that the combined footprint of the stacked strollers is equal to the footprint of a single stroller. In some embodiments, multiple strollers can be piled one on top of another to form a vertical stack. In the example shown, four strollers 100A, 100B, 100C, 100D are piled into one stack 400 (FIGS. 40-42). Generally, the canopy frame 135 and the activity bar 120 of each stroller 100 in the stack 400 have been collapsed (FIG. 44).

In general, the strollers taper downwardly from the rear R to the front F of the stroller 100. Such a design enables the strollers 100 to be stacked in a stable alternating arrangement. A first stroller 100A can be positioned on the ground in an upright orientation. A second stroller 100B can be added to form a stack 400 by flipping the second stroller 100B both horizontally and vertically such that the top of the backrest of the second stroller 100B rests adjacent the nose of the first stroller 100 and the nose of the second stroller 100B rests adjacent the backrest of the first stroller 100A.

As best shown in FIG. 42, a third stroller 100C, having the same orientation as the first stroller 100A, is added to the stack 400 by positioning the back wheels 103C of the third stroller 100C on the handlebar assemblies 102A of the first stroller 100A and positioning the front wheels 104C of the third stroller 100C within the cavity of the second stroller 100B. Additional strollers can be added to the stack 400 by alternately positioning and orientating the strollers like the second and third strollers 100B, 100C.

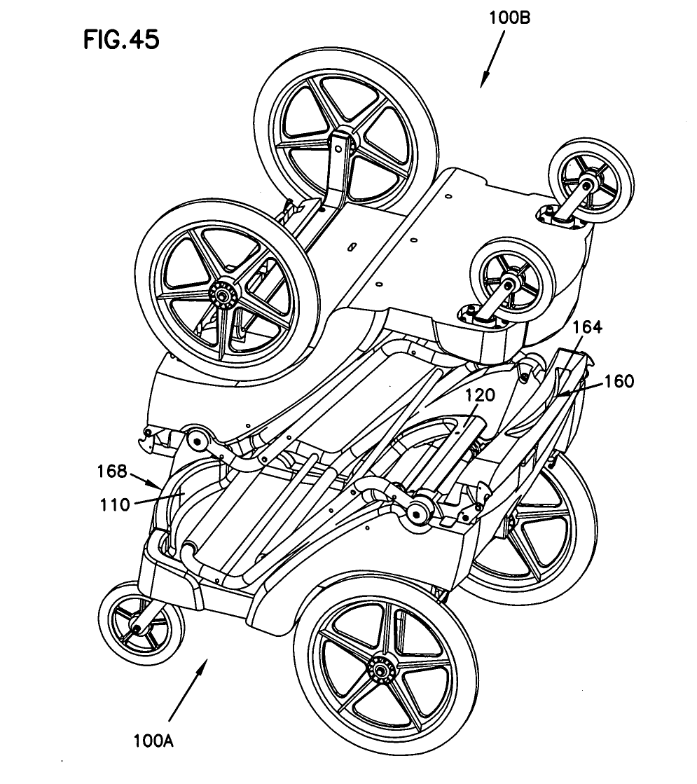

In certain embodiments, the strollers 100 are configured with at least one stacking interlock arrangement for securely stacking the strollers 100. In some such embodiments, the front F and rear R of each stroller have complementary geometries 160, 168 that enable the strollers to interlock with one another. For example, in the embodiment shown in FIGS. 44-45, a central portion 168 of the nose 110 of a stroller 100 protrudes upwardly from the foot rest area 108 sufficient to interact with a detent 164 of the formation 160 in the top, rear edge of the stroller body 101. Such interaction between the nose portion 168 and the detent 164 enables a second stroller 100B to securely mount onto a first stroller 100A.

As shown in FIG. 42, the strollers 100 can also be configured to enable a third stroller 100C, or other similarly situated stroller, to securely mount to the second stroller 100B in the stack 400. In one embodiment, the rear wheels 103B, 103C of the second and third strollers 100B, 100Care aligned along a plane. This alignment inhibits movement of the third stroller 100C towards the front of the stroller 100C. The rear, bottom portion of the third stroller 100C rests against the front wheel 104B of the second stroller 100B. This abutment inhibits movement of the third stroller 100C towards the rear of the stroller 100C.

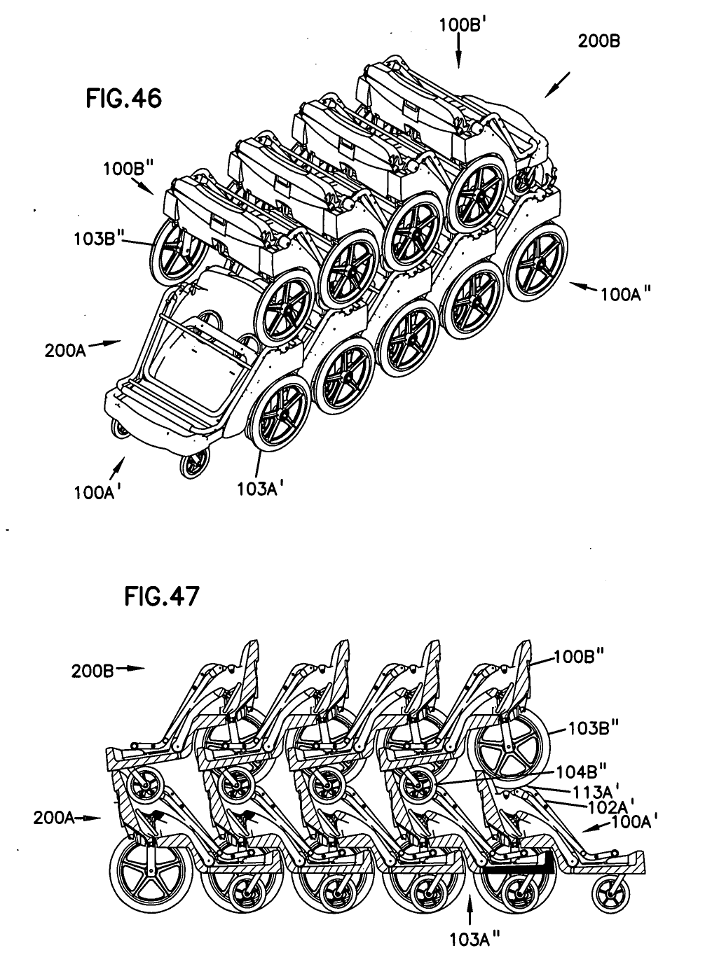

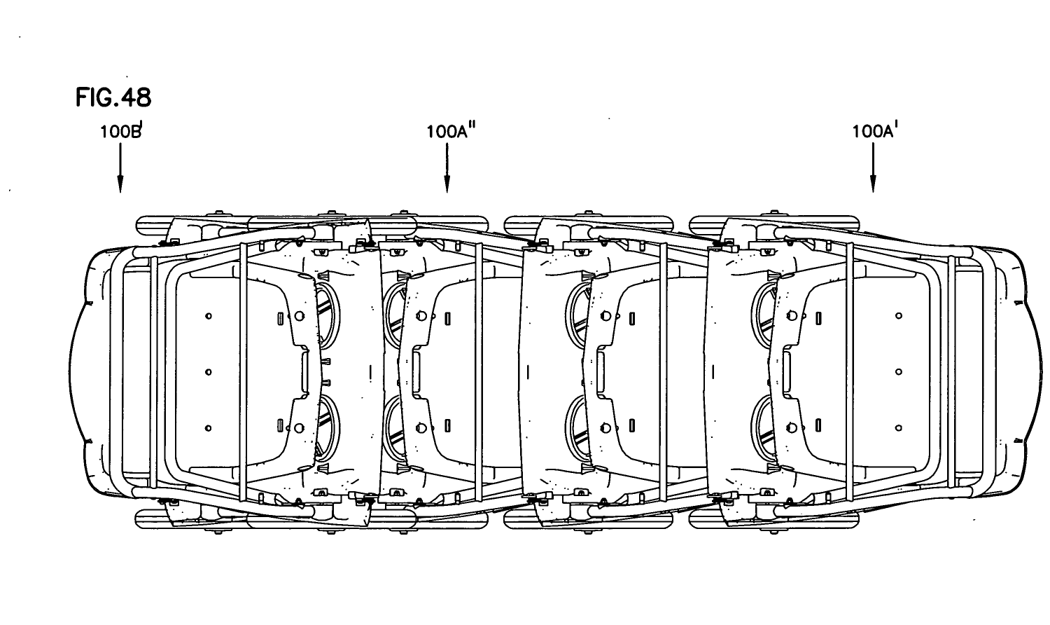

Referring now to FIGS. 46-51, the strollers 100 can also be stored in a layered configuration. As the term is used herein, “layering” strollers refers to stacking a nested row of strollers on top of another nested row of strollers. In general, a layered configuration includes a first row of nested strollers 200A resting on the ground and a second row of nested strollers 200B mounted on top of the first row 200A. In certain embodiments, the strollers 100A of rows 200A face in an opposite direction from the strollers 100B of row 200B.

In certain embodiments, the stroller 100B of the top row 200B is oriented in an upright position such that the bodies 101B of the strollers 100B rest on the wheels 103B, 104B of the strollers 100B. Because the second row 200B of strollers can be arranged in an upright position, additional rows can be arranged on top of the second row 200B. In some such embodiments, a third row of strollers (not shown) would face in the same direction as the strollers 100A of the first row 200A and face in the opposite direction as the strollers 100B of the second row 200B.

Layering provides a more efficient use of storage space than horizontal nesting, and reduces or avoids some of the dangers of vertical stacking. For example, when layering, placing into service a stroller 100B from the top row 200B involves much less effort than placing into service a stroller from the top of a vertical stack, such as stroller 100D of vertical stack 400 of FIG. 40. A user need not lift a layered stroller significantly higher than the height h of the strollers 100A of the bottom row 200A. Layered strollers 100B falling from the second row 200B are less likely to injure a bystander than strollers falling from a greater height, such as from the top of a vertical stack piled four strollers high. Additionally, in certain embodiments, the strollers 100B of the top row 200B are oriented in an upright position. In such embodiments, the strollers 100B of the top row 200B need not be flipped or rotated while being lifted off of the bottom row 200A.

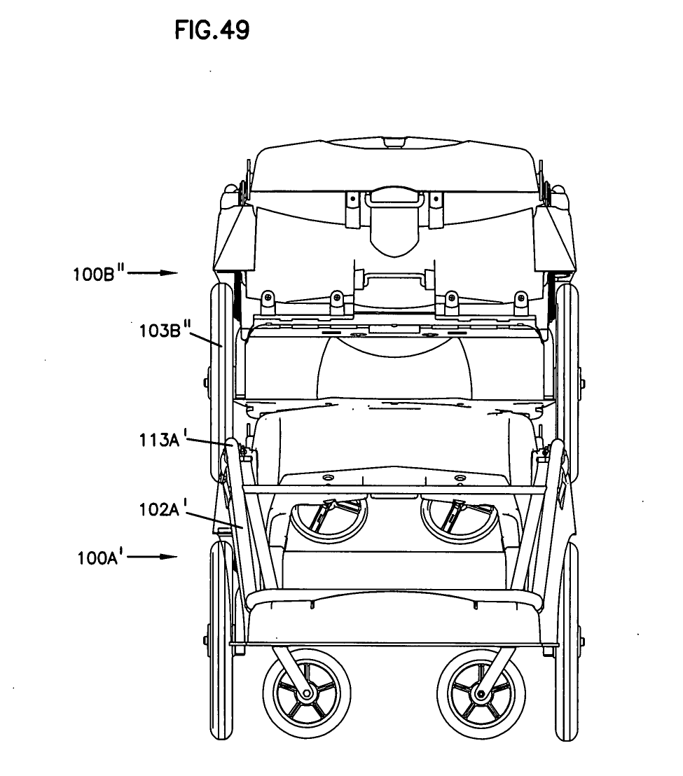

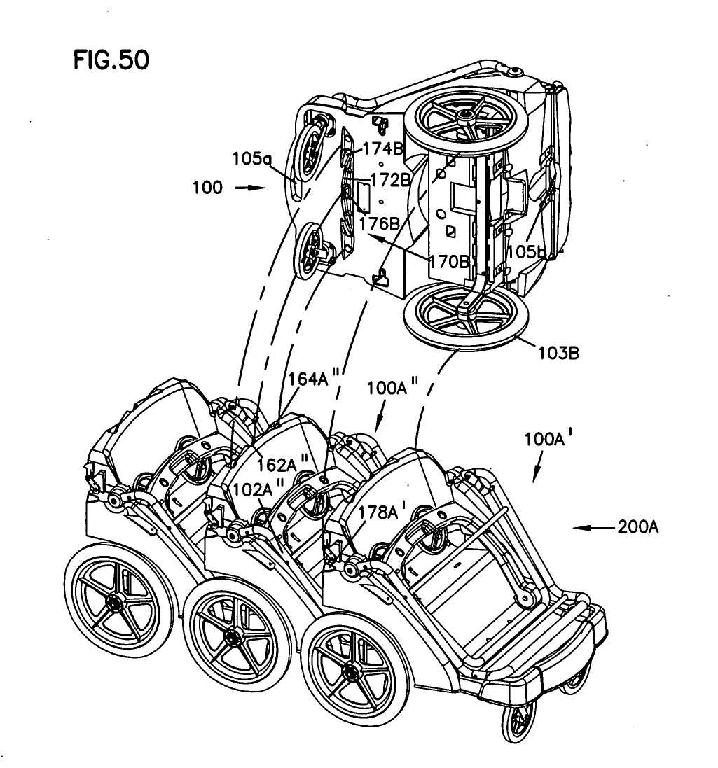

In some embodiments, the strollers 100 can be arranged such that a nose of a top stroller 100B″ rest on the backrest 107A″ of a bottom stroller 100A″. The front wheels 104B″ of the top stroller 100B″ abut the front side of the backrests 107A″ of the bottom stroller 100A″, thereby inhibiting the stroller 100B″ from moving in a direction forward of the stroller 100B″ (FIG. 47). In such embodiments, the rear wheels 103B″ of the stroller 100B″ rest on the handlebar assemblies 102A′ of an adjacent bottom stroller 100A′. In one embodiment, the handlebar assembly 102A′ of the bottom strollers 100A′ forms shoulders 113A′ (FIGS. 47 and 49) configured to inhibit movement of the top stroller 100B″ in a direction rearward of the top stroller 100B″. Additional strollers 100B can be mounted on top of the bottom row 200A in similar arrangements as shown in FIGS. 46-49.

In other embodiments, however, the strollers 100 can include a layering interlock arrangement to securely mount the strollers 100B of the top row 200B to the strollers 100A of the bottom row 200A. For example, in certain embodiments, the bottom of each stroller 100 includes a formation 170 having a geometry that is complementary to the geometry of the formation 160 at the top edge of the stroller body as shown in FIG. 44. These complementary formations 160, 170 interlock when a stroller is mounted upright on top of two nested, upright strollers.

For example, in the embodiment shown in FIG. 50, the bottom surface of each stroller 100 defines a detent 172 from which opposing curved structures 174 and a central protrusion 176 project. The curved structures 174 and the central protrusion are designed to mate with the detents 164, 166 (FIG. 44). Similarly, a protruding section 162 adjacent the detent 164 is configured to mate with the detent 172 on the bottom surface of the stroller 100. In some embodiments, the formation 170 is located between the front wheels 104 and the cavity 114 of each stroller 100. In other embodiments, however, the formation 170 can be located in any suitable location on the bottom surface of the stroller 100.

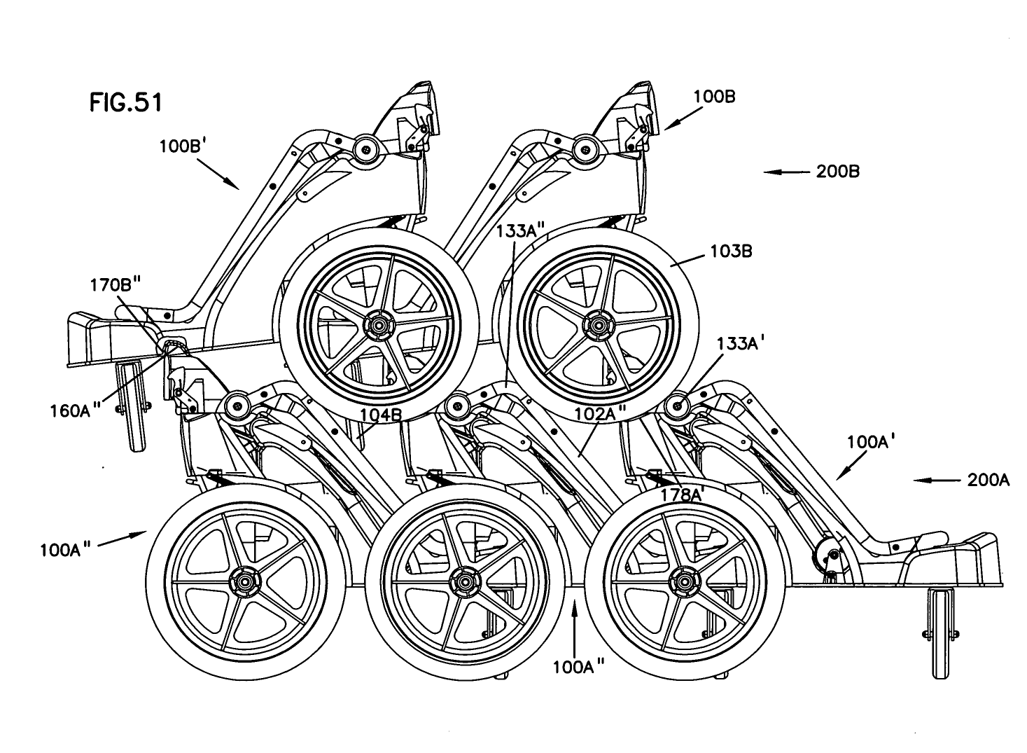

As shown in FIGS. 50-51, a first row 200A of strollers 100 is formed by nesting a second stroller 100A″ behind a first stroller 100A′ on the ground. One or more additional strollers can be nested behind the second stroller 100A″. A layered stroller 100B is mounted on top of the bottom strollers 100A′, 100A″ by positioning the formation 170B of the layered stroller 100B to mate with the formation 160A″ of the second stroller 100A″. The backs of the rear wheels 103B of the layered stroller 100B fit within rear grooves 178A′ (best shown in FIG. 44) of the first stroller 100A′. As shown in FIG. 51, the fronts of the rear wheels 103B abut the handlebar assembly 102A″ of the second stroller 100A″. As shown in FIG. 51, the front wheels 104B of the layered stroller 100B hang downwardly from the layered stroller 100B over the last stroller 100A″ in the bottom group.

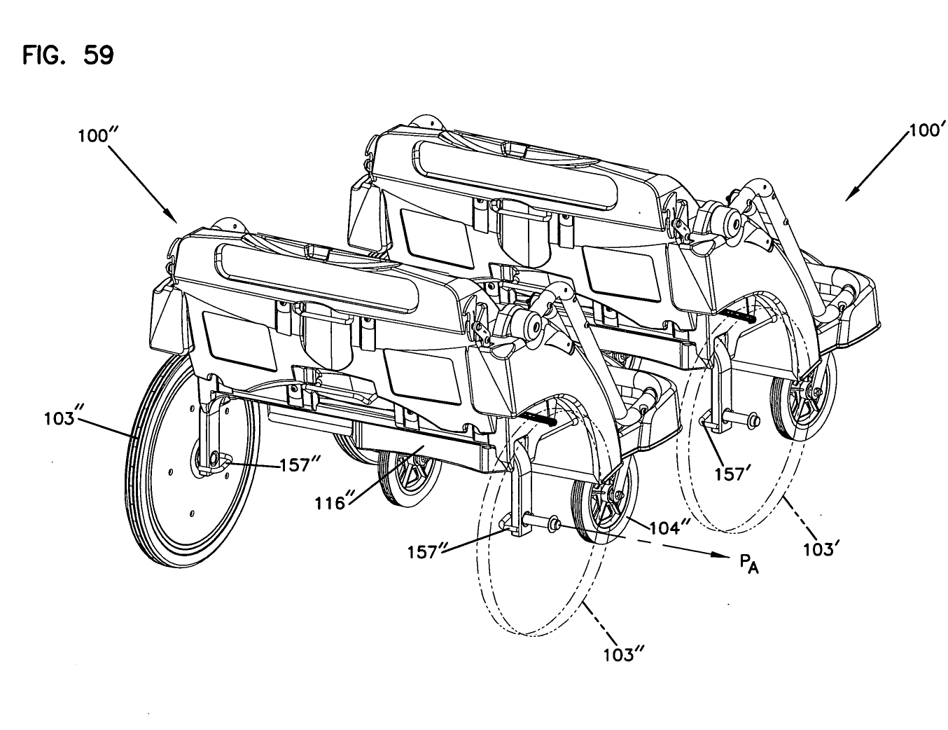

Referring to FIGS. 57-63, some strollers 100 can include a lift 157 adjacent one or both of the rear wheels 103 of the stroller 100. In some embodiments, the lift 157 can extend from the inside of the axle 115 of the stroller 100 (FIGS. 58-59). In an embodiment, the lift 157 is generally U-shaped (FIG. 58). In other embodiments, however, the lift 157 can be any suitable shape. In general, the lifts 157 can be useful in nesting, stacking, and layering of the strollers 100.

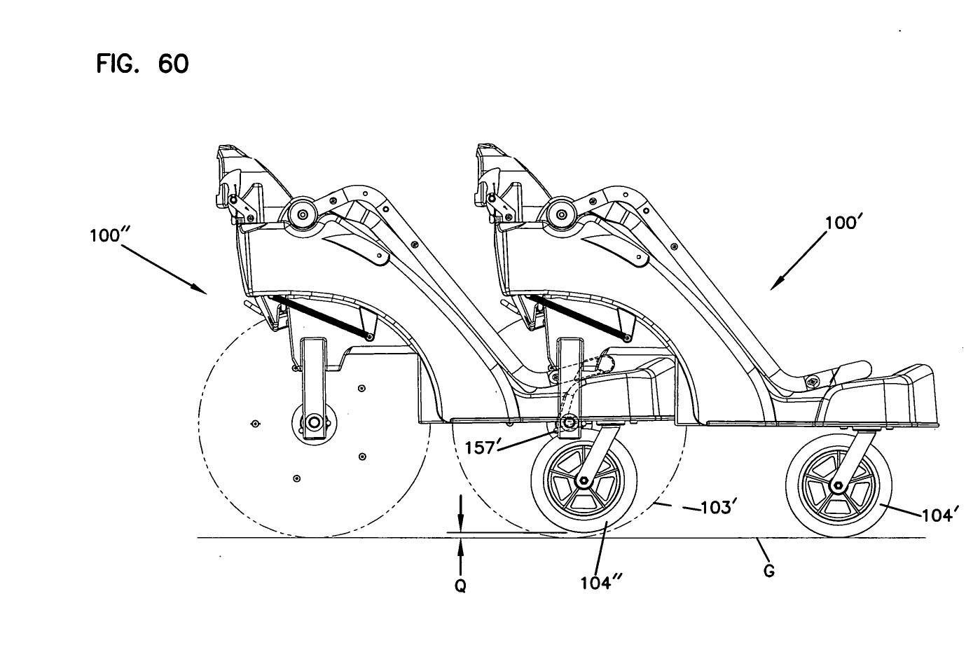

When nesting strollers 100, the lifts 157′ of a forward stroller 100′ are engaged by and support the lower front portion of a rearward stroller 100″ in a raised position when the rearward stroller 100″ is nested behind a forward stroller 100′. Raising the front portion of the rearward stroller 100″ lifts the front wheels 104″ of the rearward stroller 100″ from the ground G by a distance Q (FIG. 60).

Lifting the front wheels 104″ of the rearward stroller 100″ during nesting and unnesting of the stroller 100″ mitigates the chance of the front wheels 104″ impeding nesting or unnesting of the stroller 100″. For example, if the front wheels 104″ are caster wheels and if the front wheels 104″ are allowed to touch the ground G during nesting/unnesting, then the front wheels 104″ may rotate and catch on the rear wheels 103′ or on the underside of the forward stroller 100′.

To nest strollers 100 having lifts 157, a rearward stroller 100″ is aligned behind a forward stroller 100′ (FIG. 59). The rearward stroller 100″ is rotated about the rotational axis P_{A}″ to raise the nose 110″ of the rearward stroller 100″ (FIG. 59). The nose 110″ of the rearward stroller 100″ is then pushed into the cavity 114′ of the forward stroller so that the front of the rearward stroller 100″ slides over the lifts 157′ of the forward stroller 100′ (FIG. 60). The lifts 157 can be similarly used on layered strollers.

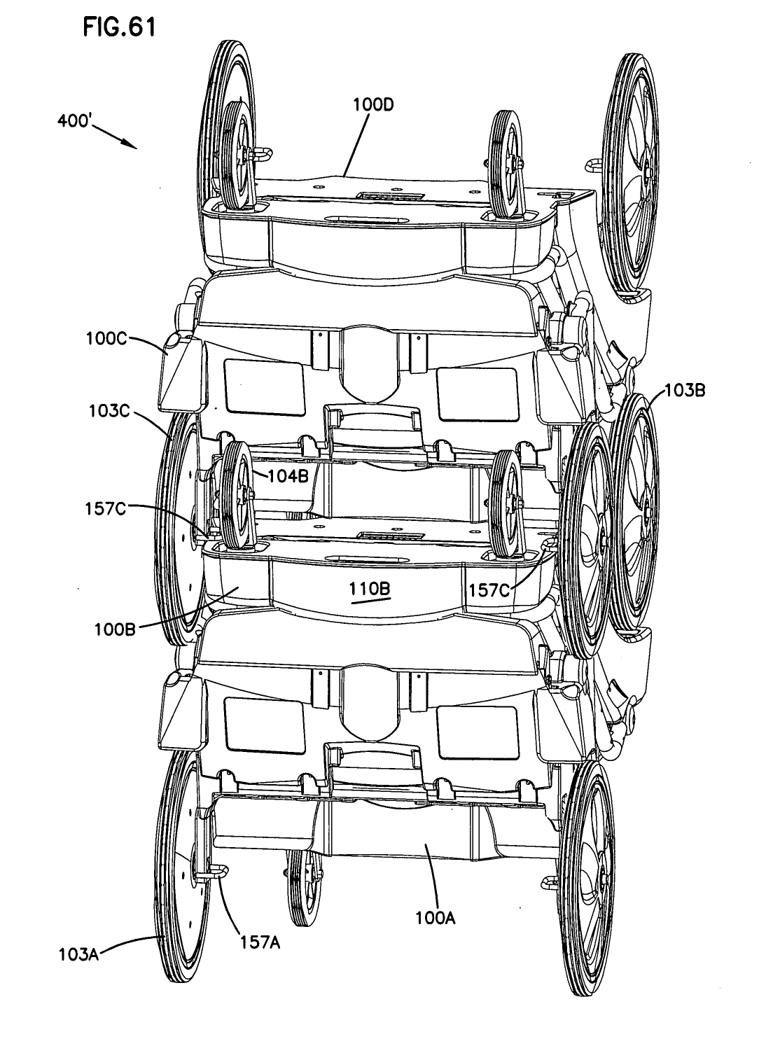

The lifts 157 also can facilitate stabilizing stacked strollers 100. For example, FIGS. 61-63 illustrate a stack 400′ of four strollers 100A, 100B, 100C, 100D. The strollers 100A, 100B, 100C, 100D are stacked as discussed above with respect to FIGS. 40-45, except strollers 100A, 100B, 100C, 100D also include lifts 157. Increased stability can enable a greater number of strollers 100 to be stacked in a single stack 400′ (i.e., and to take up a single footprint). The increased stability also can improve safety by mitigating the chances of the stack 400′ toppling.

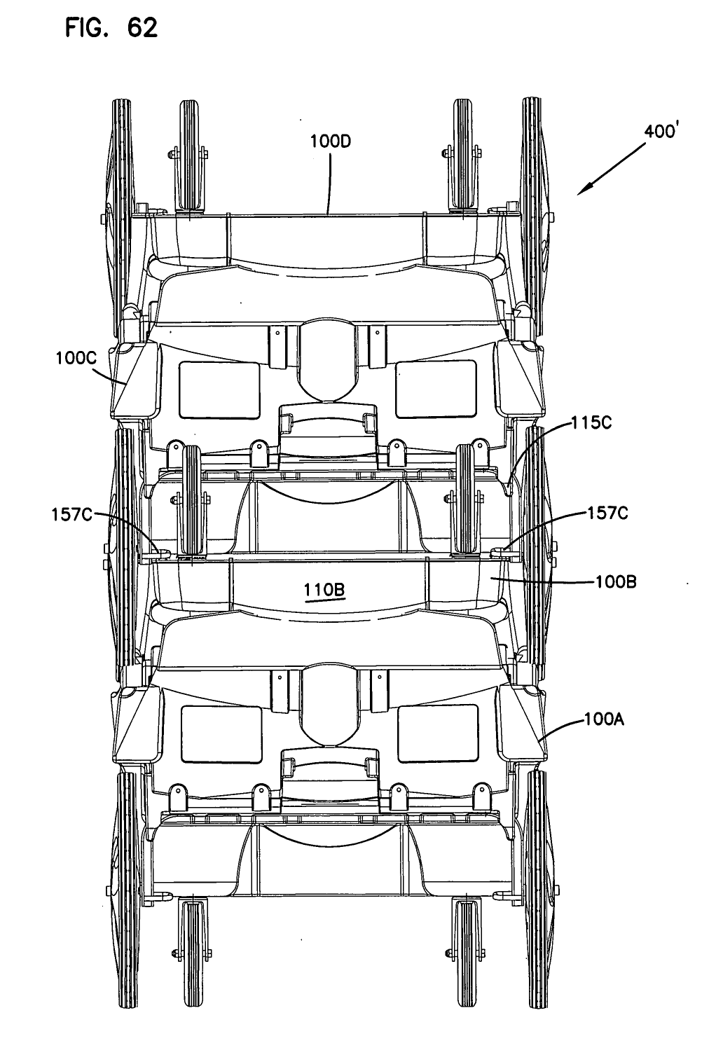

In general, the lifts 157 of a top stroller 100 rest on the bottom side of the nose 110 of a bottom stroller 100 to stabilize the rear of the top stroller 100. For example, the lifts 157C of the third stroller 100C rest against the bottom side of the nose 110B of the second stroller 100B in FIGS. 61 and 62. Due to this arrangement, the stability of the rear side of the stacked strollers is not dependent on the stability of the wheels of the strollers. For example, the third stroller 100C need not rest on the potentially unstable caster wheels 104B of the second stroller 100B or on its own rear wheels 103C.

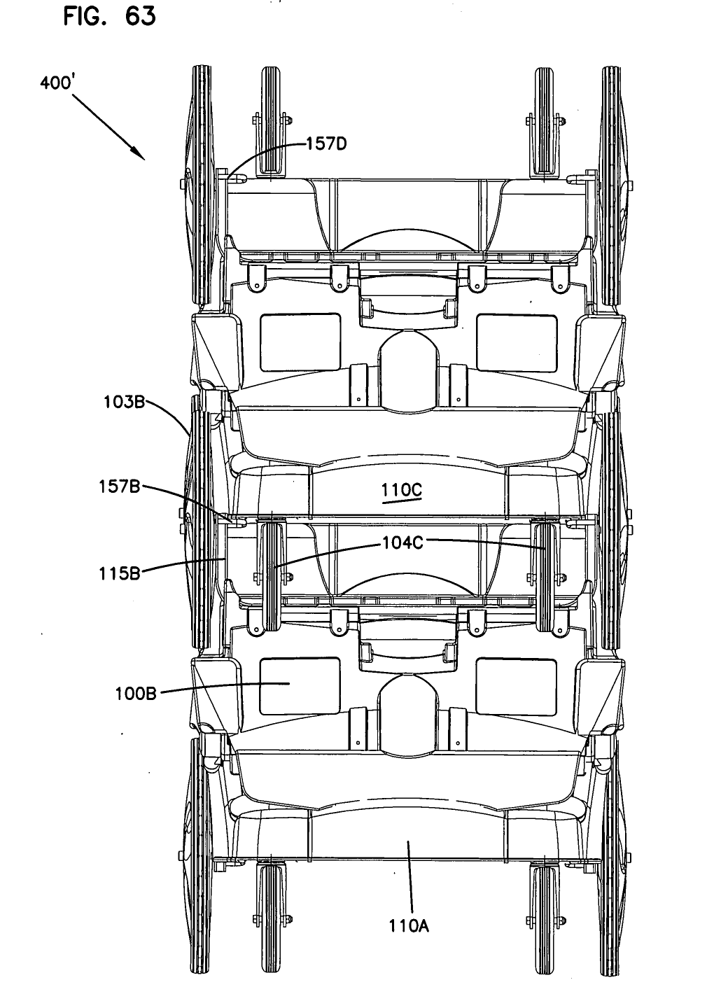

The lifts 157 of a bottom stroller 100 also can support the bottom side of the nose 110 of a top stroller to stabilize the front of the top stroller 100 (see FIG. 63). The nose 110C of the third stroller 100C rests on the lifts 157B extending from the axle 115B of the second stroller 100B. Due to this arrangement, the stability of the front of the stacked strollers is not dependent on the stability of the wheels of the strollers. For example, the nose 110C of the third stroller 100C need not rest on the caster wheels 104C of the third stroller 100C or on the rear wheels of the second stroller 100B.

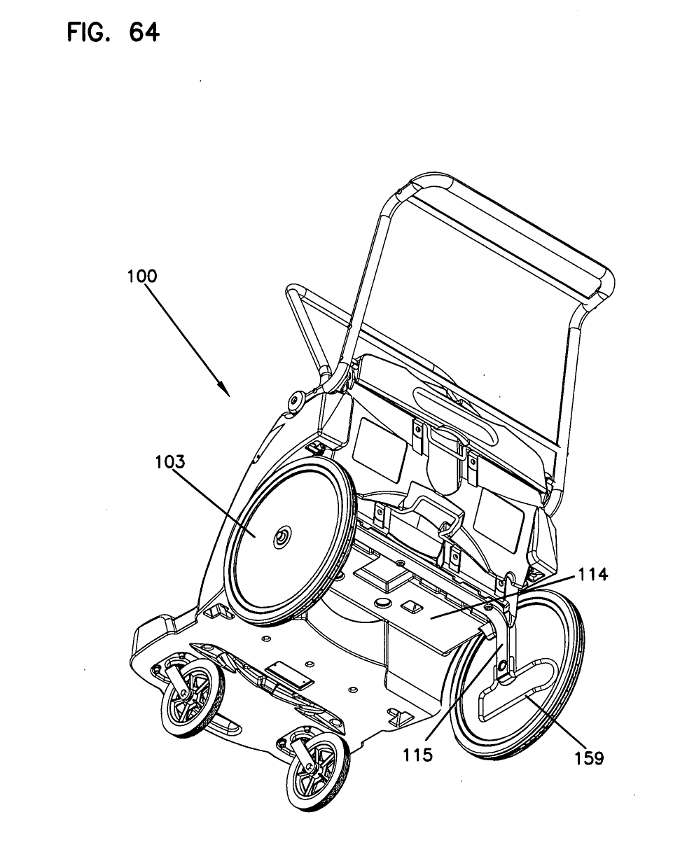

FIG. 64 illustrates an example stroller 100 having a nesting shroud 159 positioned adjacent the rear wheels 103. The nesting shroud 159 guides the nose and front wheels of a rearward stroller (not shown) into the cavity 114 of the stroller 100. The nesting shroud 159 inhibits catching of the front wheels 104 of the rearward stroller underneath the stroller 100. The shroud 159 is especially useful in strollers 100 having spoked wheels. The nesting shroud 159 can be used in place or in addition to the nesting lift 157 described above. In general, the nesting shroud 159 has an elongate body coupled to the axle 115 of the rear wheels 103. The body of the shroud 159 extends forwardly and rearwardly from the axle 115 within the diameter of the rear wheel 103.

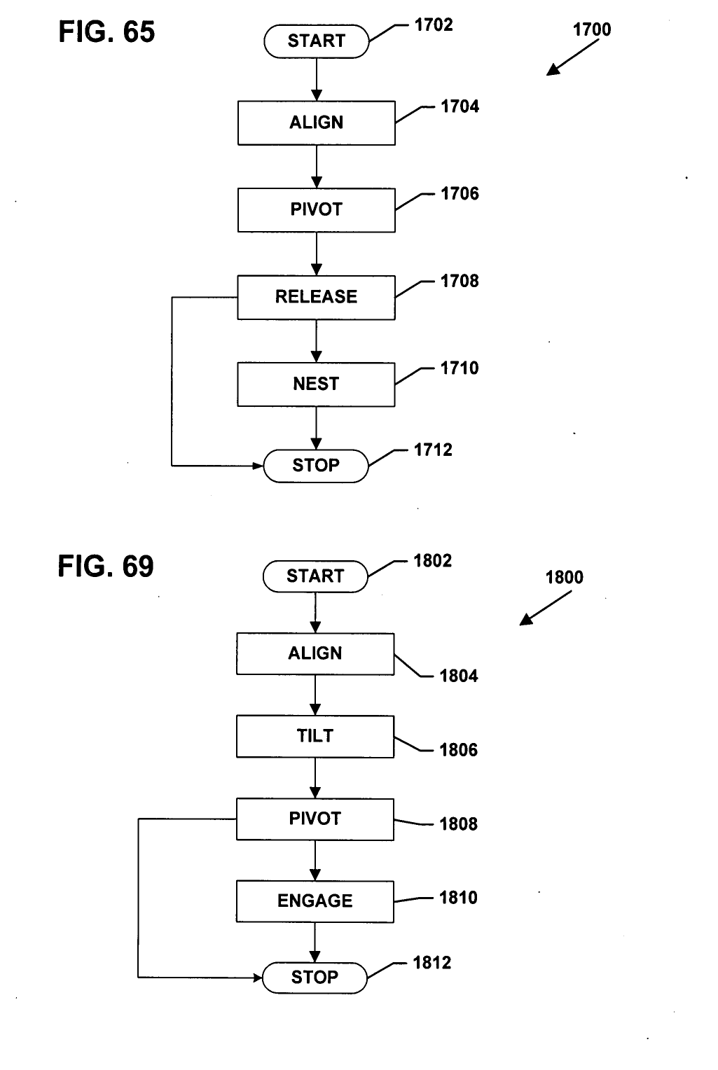

Referring to FIGS. 65-68, a user can disengage the brake on a stroller 100 without bending over to rotate the handle 181. FIG. 65 is a flowchart illustrating a brake release process 1700 by which a user can disengage the brake on a forward stroller 100′ with a rearward stroller 100″. The release process 1700 begins at start module 1702 and proceeds to an align operation 1704.

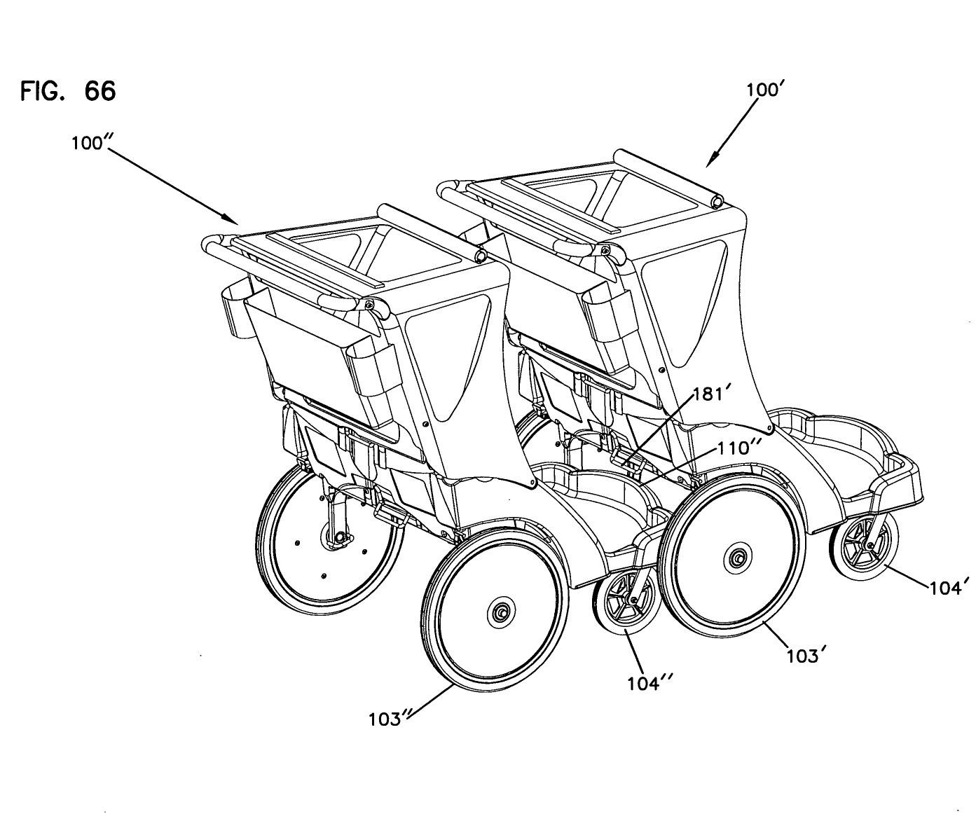

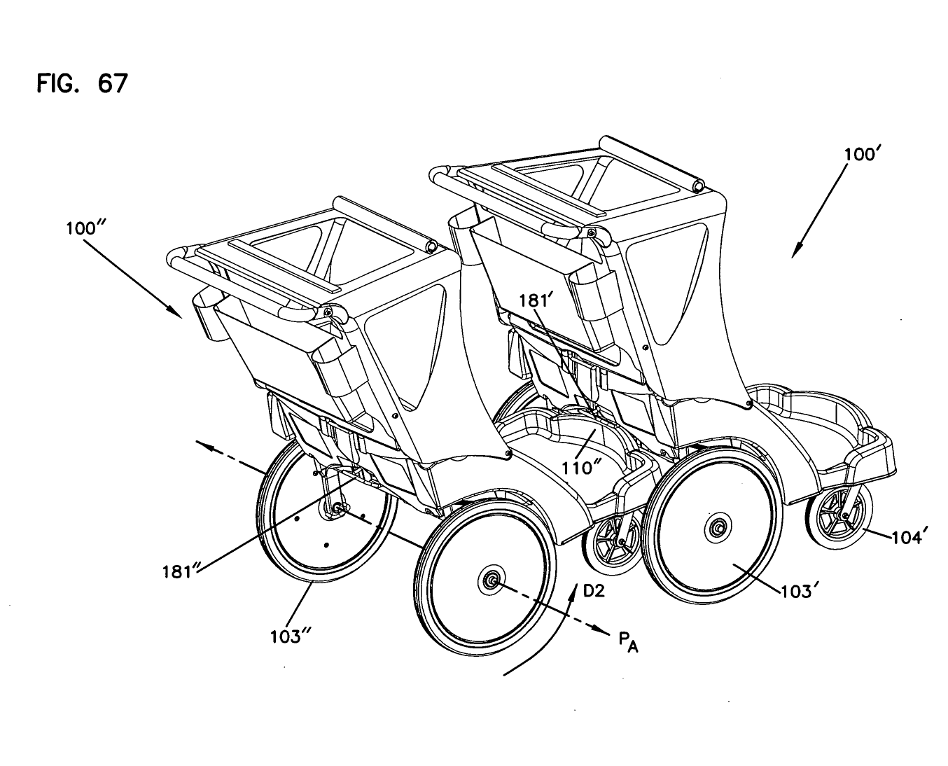

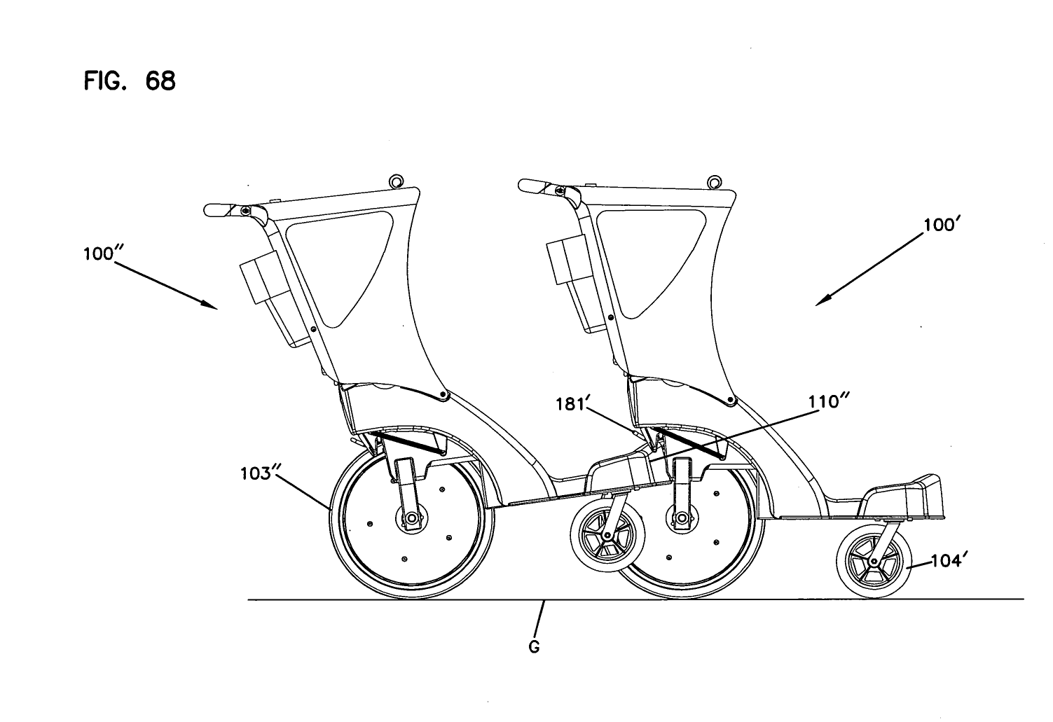

During the align operation 1704, the nose 110′ of the rearward stroller 100″ is positioned in alignment with and behind the cavity 114′ of the forward stroller 100′ (see FIG. 66). During a pivot operation 1706, the rearward stroller 100″ is pivoted about the rotation axis P_{A}″ of the rear wheels 103″ to raise the nose 110″ of the rearward stroller upwardly (FIGS. 67 and 68). During a release operation 1708, the nose 110″ of the rearward stroller 100″ engages with the brake handle 181 ′ of the forward stroller 100′ as the rearward stroller 100″ is pivoting. The nose 110″ of the rearward stroller 100″ moves the brake handle 181′ from the brake engaged position to the brake disengaged position (FIG. 68).

When the brake of the forward stroller 100′ has been disengaged, the rearward stroller 100″ optionally can be nested behind the forward stroller 100′ to form a nested group. The brake release process 1700 is now complete and ends at stop module 1712. The release process 1700 can be performed when the strollers 100 are in a canopy-up configuration as shown in FIGS. 66-68 and when the strollers 100 are in a canopy-down configuration (see e.g., FIGS. 52-56).

Referring to FIGS. 69-77, some example strollers 100 include a pivot recess 158 on the top, rear of the body 101 of the stroller 100 to facilitate stacking of the strollers 100. FIG. 69 is a flowchart illustrating a stacking process 1800 by which a user can stack a second stroller 100B on top of a first stroller 100A. The stacking process 1800 begins at start module 1802 and proceeds to an align operation 1804.

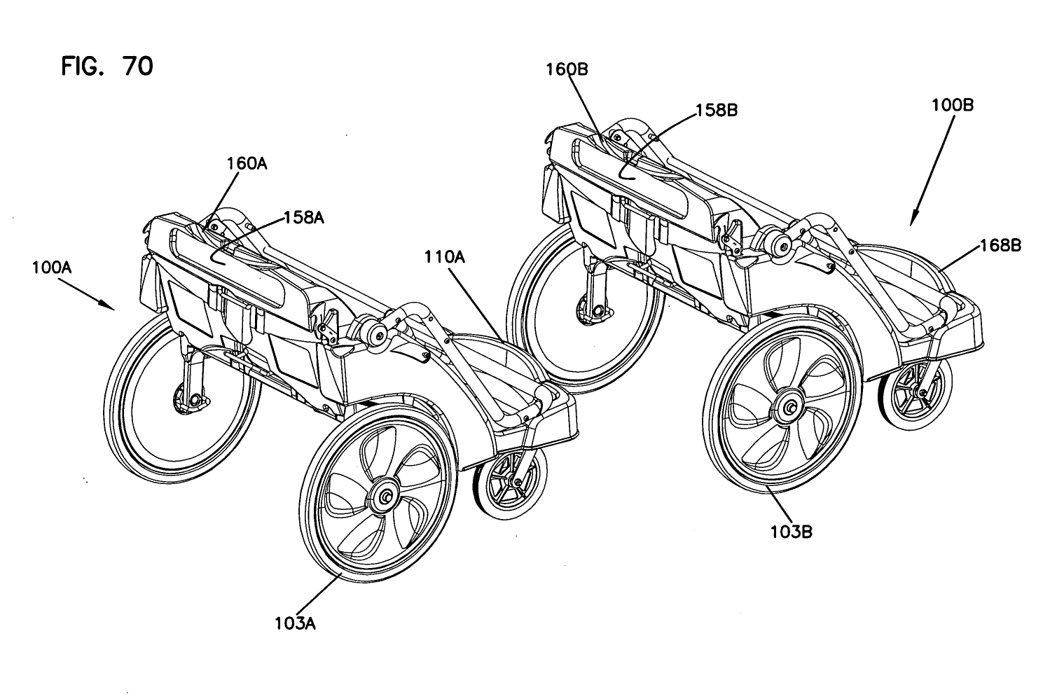

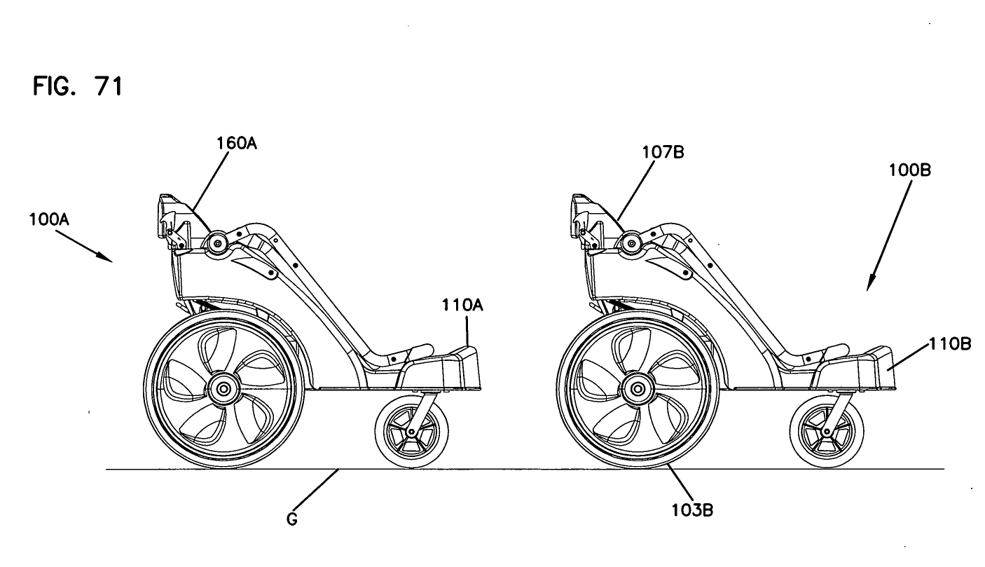

During the align operation 1804, the nose 110A of a rear stroller 100A is positioned behind the cavity of a forward stroller 100B (see FIGS. 70 and 71). At least the second stroller 100B defines a pivot recess 158B on the back of the stroller 100B. In the example shown, the pivot recess 158B has a generally elongated configuration adapted to cooperatively engage with the raised central portion 168A of the nose 110A of the first stroller 100A. In other embodiments, however, the pivot recess 158B can be any configuration adapted to engage with the nose 110A of the rearward stroller 100A.

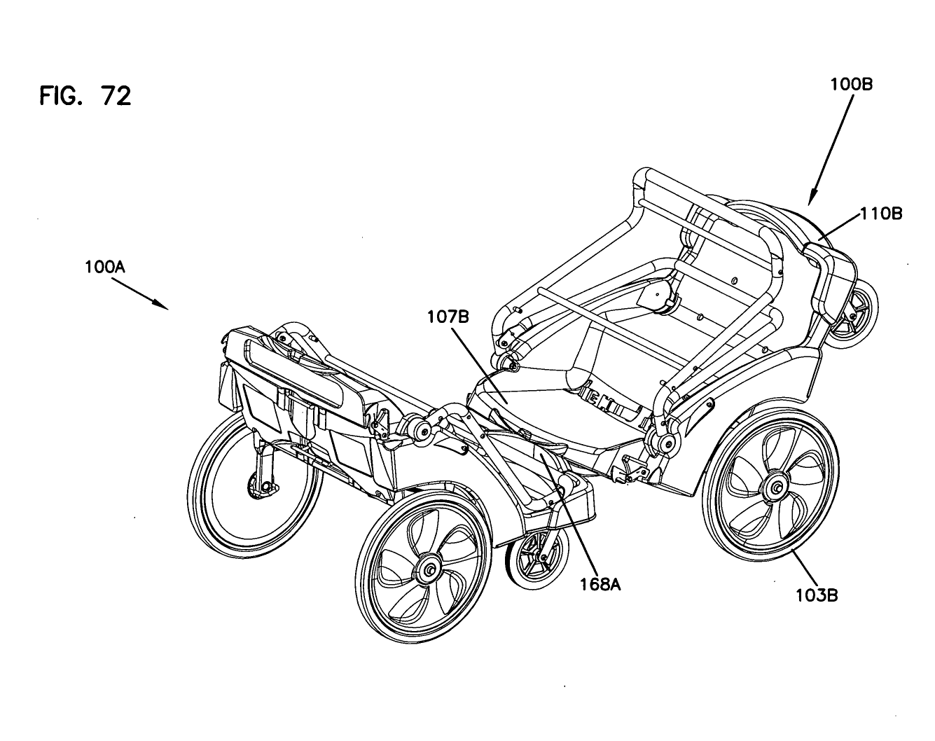

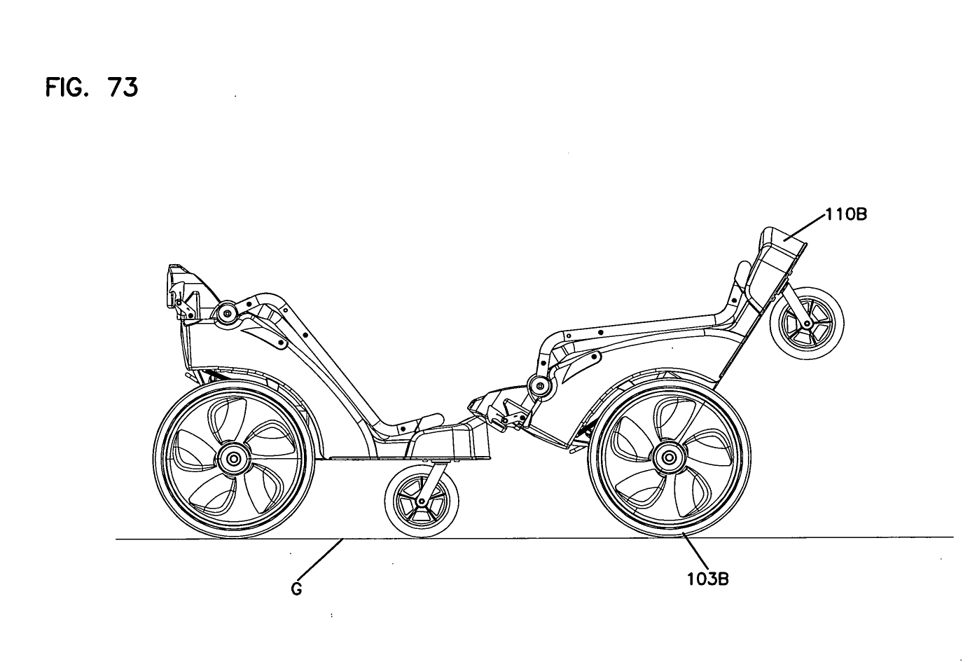

During a tilt operation 1806, the second stroller 100B pivots backwards about the rotational axis P_{A} (FIG. 67) of the rear wheels 103B of the stroller 100B (see FIGS. 72 and 73). Typically, the second stroller 100B is pivoted backwards by raising the nose 110B of the second stroller 100B upwardly. Preferably, the second stroller 100B is pivoted backwards by pulling upwardly on a handgrip 105a (FIGS. 10 and 57) defined in the front, bottom portion of the stroller 100B. During the tilt operation 1806, the second stroller 100B is pivoted counterclockwise as shown in the figures until the pivot recess 158B engages the nose 110A of the first stroller 100A (FIGS. 72 and 73).

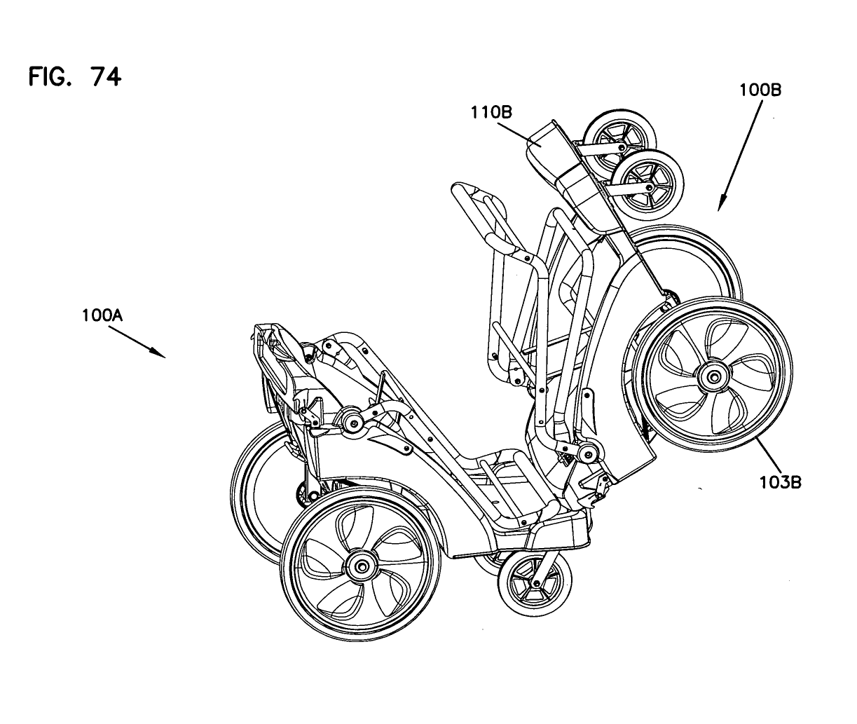

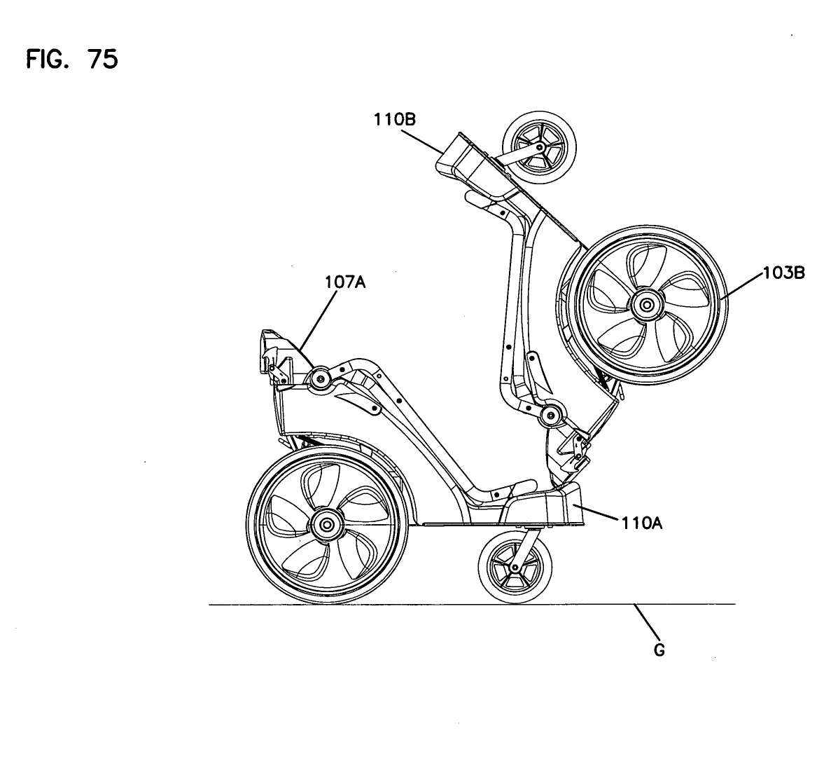

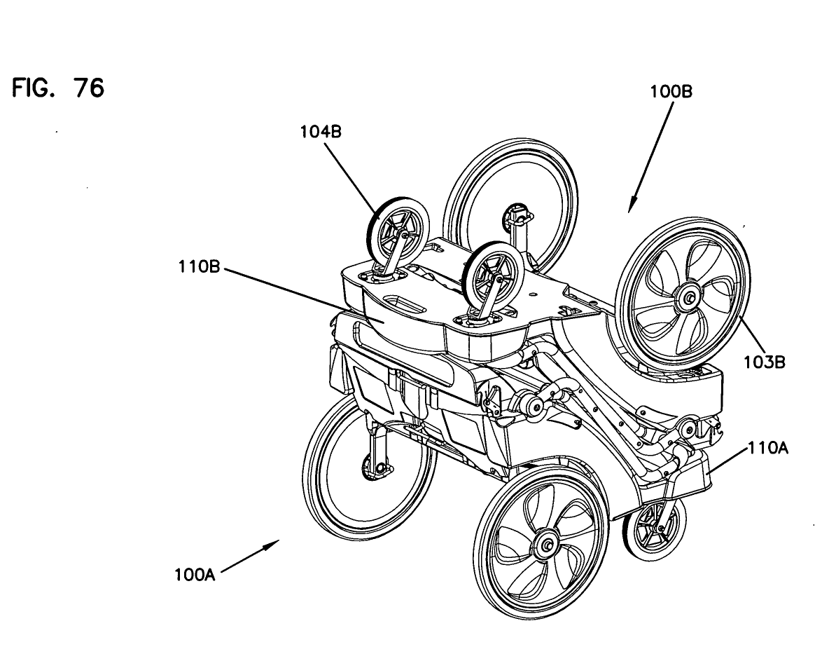

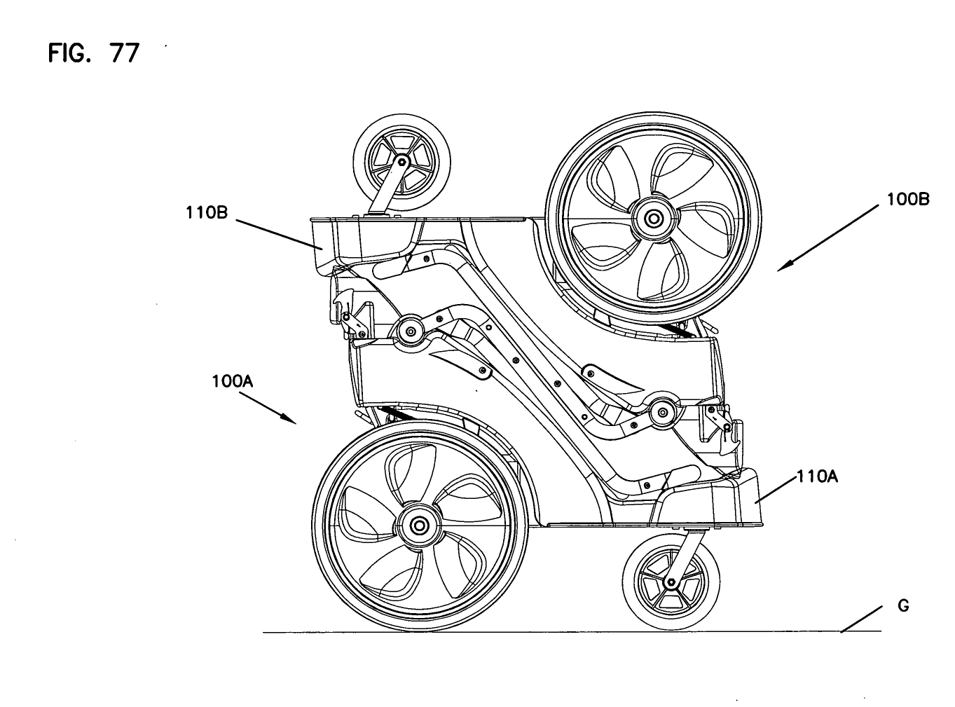

When the pivot recess 158 of the second stroller 100B engages with the nose 110A of the first stroller 100A, a pivot operation 1808 about the nose 110A of the first stroller 100A raises the second stroller 100B fully off the ground G so that not even the rear wheels 103B contact the ground G (see FIGS. 74 and 75). The weight of the second stroller 100B is supported at least partially by the nose 110A of the first stroller 100A during the pivot operation 1808. During the pivot operation 1808, the second stroller 100B is pivoted about the point of engagement between the pivot recess 158B and the nose 110A until the nose 110B of the second stroller 100B touches the top of the backrest 107A of the first stroller 100A (FIGS. 76 and 77).

An optional engage operation 1810 locks the second stroller 100B in place on top of the first stroller 100A. For example, the engage operation 1810 can interlock geometry arranged on the noses 110A, 110B of the strollers 100A, 100B with geometry arranged on the backrests 107A, 107B of the strollers 100A, 100B as described above with reference to FIGS. 40-45. The stacking process 1800 is now complete and ends at stop module 1812.

While particular embodiments of the invention have been described with respect to its application, it will be understood by those skilled in the art that the invention is not limited by such application or embodiments or by the particular components disclosed and described herein. It will be appreciated by those skilled in the art that other components and embodiments that exemplify the principles of this invention and other applications, therefore, other than as described herein, can be configured within the spirit and intent of this invention.

The arrangements described herein are provided only as examples of embodiments that incorporate and practice the broad principles of this invention. Other modifications and alterations are well within the knowledge of those skilled in the art and are to be included within the broad scope of the appended claims.

We claim:

1. A stroller system comprising:
a first stroller including a body having a front, a rear, a top, and a bottom, the body including a first interlock arrangement at the top and front of the body, the first interlock arrangement having a geometry, the body also including a second interlock arrangement at the top and rear of the body; and
a second stroller including a body having a front, a rear, a top, and a bottom, the body including a first interlock arrangement at the top front of the body, the first interlock arrangement having a geometry complementary to the geometry of the second interlock arrangement of the first stroller, the body also including a second interlock arrangement at the top rear of the body, the second interlock arrangement having a geometry complementary to the geometry of the first interlock arrangement of the first stroller, the body of the second stroller defining a cavity at the bottom rear of the body, the cavity sized to fit the top front of the first stroller;
wherein the first stroller and the second stroller form a nested group when the top front of the first stroller is inserted into the cavity of the second stroller; and
wherein the first stroller and the second stroller form a vertical stack when the first stroller is oriented to align the first interlock arrangement of the first stroller with the second interlock arrangement of the second stroller and to align the second interlock arrangement of the first stroller with the first interlock arrangement of the second stroller.

2. The system of claim 1, further comprising:
a third stroller including a body and two rear wheels, the body having a front, a rear, a top, and a bottom, the body including third interlock arrangement at the bottom of the body intermediate the front and the rear, the third interlock arrangement having a geometry configured to mate with the geometry of the second interlock arrangement of at least one of the first stroller and the second stroller;
wherein the third stroller forms a layered configuration with the first stroller and the second stroller when the third stroller is oriented to align the third interlock arrangement with the second interlock arrangement of the first stroller or the second stroller.

3. A stroller comprising:
a body having a top, a bottom, a front, and a rear, the top of the body including a seat configured to accommodate at least one passenger;
at least one front wheel coupled to the body adjacent the bottom, front of the body;
at least two back wheels coupled to opposite sides of the body adjacent the bottom, rear of the body;
a handlebar assembly configured to pivot from a first position, in which the handlebar assembly extends upwardly from the top, rear of the body, to a second position, in which the handlebar assembly extends downwardly towards the top, front of the body;
a first interlock arrangement formed adjacent the top, front of the body, the first interlock arrangement having a geometry; and
a second interlock arrangement formed adjacent the top, rear of the body, the second interlock arrangement having a geometry complementary to the geometry of the first interlock arrangement.

4. The stroller of claim 3, wherein the top, front of the body includes a nose having a height and a width, and the bottom, rear of the body defines a cavity having a height greater than the height of the nose and a width greater than the width of the nose.

5. The stroller of claim 4, further comprising an axle attached to the body within the cavity, the axle being substantially U-shaped, wherein the axle is configured to couple the two back wheels to the body.

6. The stroller of claim 3, further comprising at least one activity bar, each activity bar including a main region coupled to at least one arm extending from the body, the main region housing at least one activity.

7. The stroller of claim 6, wherein the at least one activity bar is pivotable to different positions to accommodate passengers of different sizes.

8. The stroller of claim 3, further comprising a canopy configured to protect passengers from environmental conditions, the canopy including a canopy support bar extending forwardly of the handlebar assembly; and canopy fabric extending over the canopy support bar and the handlebar assembly to form a canopy.

9. The stroller of claim 8, wherein the canopy further comprises windows.

10. The stroller of claim 8, wherein the canopy support bar extends from the handlebar assembly.

11. The stroller of claim 8, further comprising a latching system configured to collapse the canopy, the latching system including:
at least one pin extending inwardly from the handlebar assembly;
a latch rod rotatably coupled to the body adjacent the rear;
a handle coupled to the latch rod, the handle configured to enable a user to rotate the latch rod; and
at least one latch coupled to an end of the latch rod, the latch having a camming surface and a catching surface, wherein rotating the latch rod causes the latch to rotate;
wherein the at least one pin cams over the camming surface of the at least one latch and is caught by the catching surface when the handlebar assembly is pivoted to the first position, and
wherein the catching surface of the latch releases the at least one pin when the latch rod is rotated by the user via the handle.

12. The stroller of claim 3, wherein the front wheels include caster wheels.

13. The stroller of claim 3, further comprising a braking system, the braking system including:
a brake rod rotatably coupled to the body adjacent the rear;
brake tabs coupled to either end of the brake rod, the brake tabs configured to rotate about a longitudinal axis of the brake rod from a release position in which the brake tabs do not contact the rear wheels to a contact position in which the brake tabs contact the rear wheels; and
a spring coupled to the brake tabs to bias the brake tabs against the wheel when the brake tabs are in the contact position.

14. The stroller of claim 3, further comprising a third interlock arrangement located adjacent the bottom of the body, the third interlock arrangement having a geometry complementary to the geometry of the second interlock arrangement.

15. The stroller of claim 3, wherein the body includes a pass-through area configured to facilitate loading and unloading of the stroller.

16. A stroller comprising:
a body having a top, a bottom, a front, and a rear, the top of the body including a seat configured to accommodate at least one passenger;
at least one front wheel coupled to the body adjacent the bottom, front of the body;
at least two back wheels coupled to opposite sides of an axle positioned on the body adjacent the bottom, rear of the body; and
at least one activity bar, each activity bar including a main region coupled to at least one arm extending from the body, the main region providing at least one activity, the at least one activity bar configured to pivot between multiple positions.

17. The stroller of claim 16, wherein the at least one activity bar is configured to pivot from a first position adapted for transporting passengers to a second position adapted for loading and unloading the stroller.

18. The stroller of claim 16, wherein the at least one activity bar is configured to pivot from a first position adapted for transporting passengers to a storage position.

19. The stroller of claim 18, wherein pivoting the at least one activity bar to the storage position enables the handlebar assembly to pivot to the second handlebar position.

20. The stroller of claim 16, wherein the activity provided on the main region of the at least one activity bar includes at least one mock steering wheel.

21. The stroller of claim 16, further comprising a first lift extending inwardly from a first side of the axle and a second lift extending inwardly from a second side of the axle.

22. A stroller comprising:
a body having a top, a bottom, a front, and a rear, the top of the body including a seat configured to accommodate at least one passenger;
at least one front wheel coupled to the body adjacent the bottom, front of the body;
at least two back wheels coupled to opposite sides of an axle positioned on the body adjacent the bottom, rear of the body; and
a first lift arranged adjacent the bottom of the body, the first lift configured to raise at least a first front wheel of a second stroller when the second stroller is nested behind the body of the stroller.

23. The stroller of claim 22, wherein the first lift is arranged adjacent the rear of the body.

24. The stroller of claim 22, further comprising a second lift arranged adjacent the bottom of the body, the first lift configured to raise at least a second front wheel of the second stroller being nested behind the body of the stroller.

25. The stroller of claim 22, wherein the first lift is configured to stabilize the stroller when the stroller is stacked on a third stroller.

26. The stroller of claim 22, wherein the first lift is configured to at least partially support a third stroller stacked on the stroller.

27. The stroller of claim 22, wherein the first lift is generally U-shaped.

28. A stroller comprising:
a body having a top, a bottom, a front, and a rear, the top of the body including a seat configured to accommodate at least one passenger;
at least one front wheel coupled to the body adjacent the bottom front of the body;
at least two back wheels coupled to opposite sides of the body adjacent the bottom rear of the body;
a first formation arranged adjacent the top of the body, the first formation having a geometry; and
a second formation arranged adjacent the bottom of the body, the second formation having a geometry complementary to the geometry of the first formation to facilitate layering of the stroller with another stroller of like configuration.
